(19) United States
(12) Patent Application Publication
(10) Pub. No.: US 2020/0329702 A1
(43) Pub. Date: Oct. 22, 2020

(54) Thermal Consistency Systems and Methods for the Application of Thermal Support to a Human or Animal Body or to an Organ for Transplantation

(71) Applicant: David PENSAK, Wilmington, DE (US)

(72) Inventor: David PENSAK, Wilmington, DE (US)

(21) Appl. No.: 16/095,884

(22) PCT Filed: Apr. 26, 2017
(86) PCT No.: PCT/US2017/029592

§ 371 Date: Oct. 23, 2018

Related U.S. Application Data
(60) Provisional application No. 62/328,287, filed on Apr. 27, 2016.

(51) Int. Cl. A01N 1/02; B01L 7/04; F17C 3/08

(52) U.S. Cl. CPC A01N 1/0273; B01L 7/04; F17C 3/085; F17C 2203/0658; B01L 2300/18; F17C 2201/018; F17C 2203/0685; B01L 2300/123

(57) ABSTRACT

Thermal consistency devices and systems that utilize phase change materials to provide thermal support to the body part of a human or animal within a precise temperature range for extended periods, without the need for mechanical heating or cooling or thermal support provided by chemical reactions, are disclosed. Methods of applying precise, controlled, and consistent thermal support to the body part of a human or animal utilizing phase change materials are also disclosed.

### FIELD OF THE INVENTION

This invention relates to the application of precise and controlled temperature gradients to a human or animal body or to an organ for transplantation. In particular, the invention provides thermal consistency systems, devices, and methods utilizing phase change materials for providing consistent thermal support to a human or animal body or to an organ for transplantation.

### BACKGROUND

The application of heat or cold to a human or animal body has many therapeutic benefits. For instance, heat therapy can be applied for the relief of pain and for rehabilitation purposes. The therapeutic effects of heat include increasing the extensibility of collagen tissues, decreasing joint stiffness, reducing pain, relieving muscle spasms, and the like. Often, heat therapy takes the form of a hot cloth, hot water, ultrasound, and heating pads. In addition to its therapeutic uses, application of heat can be used to keep a human or animal body warm in extremely cold temperature environments thereby preventing frostbite or hypothermia.

In addition to heat, the application of ice treatment has therapeutic benefits. Applying ice to an injury constricts the blood vessels, which reduces blood flow to and swelling around an injury site. Ice treatment also numbs the area, which reduces pain and helps to prevent muscle spasms. In addition, ice and other cooling measures can be used for treating hyperthermia, which is a condition characterized by elevated body temperatures due to failed thermoregulation (e.g., heat stroke). Finally, lowering the temperature of an injured area may slow certain localized cellular processes, which can actually help to limit tissue damage.

In addition to applying thermal support to the body or body part of a human or animal, the application of heat or cold to fluids intended for use in a human or animal (e.g., transfusion of blood and/or blood products, lactated Ringer's solution, and saline) is also essential to ensure such fluids do not deviate too far from normal physiological temperatures. Failure to do so may result in cardiac arrest of the human or animal and cause irreversible tissue damage. Furthermore, organs that are removed from an human or animal that are intended for transplant must be maintained at tightly controlled temperatures during transport and/or while awaiting transplantation into a recipient human or animal.

Traditional applications of heat or cold, however, are not without limitations. First, the application of heat using ultrasound, electric heating pads, lasers, and the like may require large amounts of energy and can be very costly. In addition, many of the automated devices for thermal support require specialized training and may not be available to non-professionals. For example, thermal support via laser heat treatment requires special protective glasses and may not be available for purchase to an individual who is not a board certified physical therapist. On the other hand, hot compresses can lose their warmth rapidly, thereby limiting the therapeutic benefit. Even heating pads utilizing chemical reactions have drawbacks in that they are often not reusable. Furthermore, heat therapy requiring elevated temperatures must be carefully monitored to prevent burns. What is more, certain animals, such as canines, have far less capability to handle thermal regulation as compared to humans thereby requiring extra caution when treating to avoid overheating. With regard to the use of ice packs and the like, prolonged exposure to ice can increase the risk of developing frostbite and may even cause nerve and tissue damage. The use of ice also limits the range of temperatures that can be used for thermal support.

One alternative to the above-discussed methods of thermal support is the use of phase change materials (“PCMs”). A PCM is a material that has a high latent heat of fusion such that a large amount of heat energy must be applied to or absorbed from the PCM to change the PCM from a solid to a liquid or from a liquid to a solid. At temperatures above and below a PCMs melting point, the PCMs temperature rises at it absorbs heat from the surrounding environment. However, at the PCM's melting point, the PCM absorbs heat without increasing temperature until a change of state from solid to liquid of the entire mass has occurred.

On the other hand, when the ambient temperature around a liquid PCM material falls, the temperature of the PCM begins to fall until it reaches its freezing point. At this point, the PCM beings to crystallize and heat energy is released. However, until the entire mass of the PCM has solidified, the temperature of the PCM will not decrease in response to the surrounding temperature. Many PCMs are available having melting temperatures in many temperature ranges, including from temperature ranges from about −30° C. to up to about 190° C. PCM-containing energy storage systems have been used for thermal storage for lighting systems, solar heating devices, and packaging. For example, U.S. Pat. No. 6,482,332 discloses a thermal packaging system that utilizes a single PCM in part liquid and part solid form to confine the temperature of a product within a predetermined temperature range. U.S. Pat. No. 7,969,075 discloses a thermal storage system using encapsulated phase change materials in LED lamps. U.S. Pat. No. 4,708,812 discloses solid phase change materials encapsulated in a condensation polymeric shell to provide heat storage material in solar heating devices.

A need exists, however, for a thermal application device that can be used on the human or animal body or on an organ intended for transplantation for precise temperature maintenance and consistent thermal support. More particularly, there exists a need for thermal application devices that can conform to a body part of a human or animal with a large enough mass to effectively store latent heat while being small enough to avoid causing the wearer discomfort or interfering with the wearer's mobility. The present invention satisfies this need.

### SUMMARY

One aspect of the invention features a thermal consistency system comprising at least one first enclosure in which is disposed a phase change material, wherein the at least one first enclosure comprises at least one conformable layer, and wherein the phase change material of the at least one first enclosure has a melting temperature range within 2° C. of a predetermined temperature. In addition, the thermal consistency system comprises at least one second enclosure in which is disposed a phase change material, wherein the at least one second enclosure comprises at least one conformable layer, wherein the phase change material of the at least one second enclosure has a melting temperature range within 15° C. of the predetermined temperature. Particularly, the melting temperature range of the phase change material of the first enclosure is different than the melting temperature range of the phase change material of the second enclosure, wherein each first enclosure is adjacent to at least one second enclosure, wherein each first enclosure is within a proximity to the adjacent second enclosure whereby convective heat transfer occurs between the first enclosure and the adjacent second enclosure, and wherein the thermal consistency system is enabled to maintain at least the surface of an object, when placed in substantially direct contact with at least one of the first enclosure, within about 2° C. of the predetermined temperature for at least about 1 hour.

In certain embodiments, the predetermined temperature is in a temperature range from about −5° C. to about 85° C., and wherein the melting temperature range of the phase change material of the first enclosure is within 10° C. of the melting temperature range of the phase change material of the second enclosure. In other embodiments, the melting temperature range of the phase change material of the first enclosure is from about 5° C. to about 10° C., and the melting temperature range of the phase change material of the second enclosure is from about −2° C. to about 4° C.

In yet other embodiments, the predetermined temperature is in a temperature range from about −5° C. to about 85° C., wherein the melting temperature of the phase change material of the first enclosure is within 15° C. of the melting temperature range of the phase change material of the second enclosure. In yet other aspects, the melting temperature range of the phase change material of the first enclosure is from about 60° C. to about 70° C., and the melting temperature range of the phase change material of the second enclosure is from about 75° C. to about 85° C.

In certain aspects, the invention features a thermal consistency system wherein the phase change material of the first enclosure, the phase change material of the second enclosure, or both, comprises one or more inorganic salt, hydrated inorganic salt, or a combination of an inorganic salt and a hydrated inorganic salt. In particular, the at least one inorganic salt is selected from the group consisting of NaCl, KCl, and CaCl₂.

In other aspects, the phase change material of the first enclosure, the phase change material of the second enclosure, or both, comprises at least one organic molecule. In particular, the at least one organic molecule is selected from the group consisting of a long chain fatty acid, polyol, paraffin, and polyacrylamide.

In some embodiments, the at least one conformable layer of the first enclosure, the second enclosure, or both, comprises a flexible polymer. In other embodiments, the flexible polymer is selected from the group consisting of polyamide, polyethylene, polychlorotrifluoroethene, polystyrene, polyethylene terephthalate, and polypropylene. In yet other embodiments, the at least one conformable layer of the first enclosure, the second enclosure, or both, comprises a flexible, thermally conductive material having a thermal conductivity of at least 30 W/mK. In particular, the flexible, thermally conductive material comprises a metal selected from the group consisting of aluminum and copper.

In certain embodiments, the thermal consistency system comprises a conformable outer encasement in which is disposed the at least one first enclosure and the at least one second enclosure, wherein each first enclosure is adjacent to at least one second enclosure, and wherein each first enclosure is within a proximity to the adjacent second enclosure whereby convective heat transfer occurs between the first enclosure and the adjacent second enclosure.

In some embodiments, the at least one first enclosure and the at least one second enclosure each have a length from about 1.27 cm to about 10.16 cm, a width from about 1.27 cm to about 3.81 cm, and a thickness from about 0.508 cm to about 2.54 cm.

In other embodiments, the phase change material of the first enclosure has a melting temperature range from about 5° C. to about 10° C. and comprises paraffin, wherein the phase change material of the second enclosure has a melting temperature range from about −2° C. to about 4° C. and comprises a polyacrylamide network containing water, and wherein each first enclosure and each second enclosure comprises at least two conformable layers comprising a flexible polymer layer and a flexible, thermally conductive material having a thermal conductivity of at least 30 W/mK.

In yet other embodiments, the thermal consistency system further comprises a separator element between each first enclosure and the adjacent second enclosure, wherein each first enclosure does not contact directly the adjacent second enclosure, wherein each first enclosure is within a proximity to the adjacent second enclosure whereby convective heat transfer occurs between the first enclosure and the adjacent second enclosure, and wherein the thermal consistency system is enabled to maintain at least the surface of an object, when placed in substantially direct contact with at least one of the first enclosure, within about 2° C. of the predetermined temperature for at least 6 hours.

In some embodiments, the convective heat transfer between the first enclosure and the adjacent second enclosure increases the length of time that the thermal consistency system can maintain the surface of the object within about 2° C. of the predetermined temperature by at least 10%. More particularly, the convective heat transfer between the first enclosure and the adjacent second enclosure increases the length of time that the thermal consistency system can maintain the surface of the object within about 2° C. of the predetermined temperature by at least 20%.

Another aspect of the invention features a thermal consistency device comprising an enclosure in which is disposed a phase change material having a melting temperature range within 2° C. of a predetermined temperature, wherein the enclosure comprises a thermoplastic polymer material, and wherein the enclosure has: (i) an outer circumference; and (ii) a longitudinal axis comprising a top end and a bottom end, a water-permeable thermal applicator comprising a matrix of absorbent material, and a thermal convection liquid, wherein the water-permeable thermal applicator is disposed on at least a portion of the bottom end of the enclosure, wherein the thermal convection liquid is disposed within the matrix of absorbent material whereby convective heat transfer occurs between the enclosure and the surface of an object when placed in substantially direct contact with at least a portion of the water-permeable thermal applicator.

In one embodiment, the thermoplastic polymer material is polypropylene and the longitudinal axis of the enclosure has a length greater than the outer circumference of the enclosure. In another embodiment, the absorbent material is selected from the group consisting of cellulose, low-density polyether, polyester, polyurethane, and polyvinyl alcohol. In yet another embodiment, the thermal convection liquid comprises water. In a particular embodiment, the thermal convection liquid further comprises one or more additives whereby the freezing temperature of the water is lowered.

In some embodiments, the predetermined temperature is in a temperature range from about −5° C. to about 85° C. In other embodiments, the predetermined temperature is in a temperature range from about 5° C. to about 15° C., and the phase change material comprises an organic molecule selected from the group consisting of paraffin and a long chain fatty acid.

Yet another aspect of the invention features a method of applying consistent thermal support to a human or animal body part or to an organ for transplantation within a predetermined temperature range for up to a predetermined time, the method comprising providing a thermal consistency device comprising at least one first enclosure in which is disposed a first phase change material, wherein the at least one first enclosure comprises at least one conformable layer, and wherein the first phase change material has a melting temperature range within 2° C. of a predetermined temperature, charging the thermal consistency device, placing the charged thermal consistency device within close proximity to a human or animal body part or an organ for transplantation, and maintaining the charged thermal consistency device within close proximity to the human or animal body part or organ for transplantation for up to the predetermined time, whereby the temperature on at least the surface of the human or animal body part or organ for transplantation is maintained within 2° C. of the predetermined temperature for up to the predetermined time.

In some embodiments, the charged thermal consistency device is placed in substantially direct contact with the human or animal body part or organ for transplantation. In other embodiments, the first phase change material comprises one or more inorganic salt, hydrated inorganic salt, or a combination of an inorganic salt and a hydrated inorganic salt. In particular, the at least one inorganic salt of the first phase change material is selected from the group consisting of NaCl, KCl, and CaCl₂.

Alternatively, in some embodiments, the first phase change material comprises at least one organic molecule. In particular, the at least one organic molecule of the first phase change material is selected from the group consisting of a long chain fatty acid, polyol, paraffin, and polyacrylamide.

In one embodiment, the at least one conformable layer of the first enclosure comprises a first flexible polymer. In particular, the first flexible polymer is selected from the group consisting of polyamide, polyethylene, polychlorotrifluoroethene, polystyrene, polyethylene terephthalate, and polypropylene. In other embodiments, the at least one conformable layer of the first enclosure comprises a first flexible, thermally conductive material having a thermal conductivity of at least 30 W/mK. More particularly, the first flexible, thermally conductive material comprises a metal selected from the group consisting of aluminum and copper. In some aspects of the invention, the predetermined temperature of the method is in a temperature range from about −5° C. to about 85° C.

In some embodiments, the thermal consistency device further comprises at least one second enclosure in which is disposed a second phase change material, wherein the at least one second enclosure comprises at least one conformable layer, and wherein the second phase change material has a melting temperature range within 15° C. of the predetermined temperature, wherein the melting temperature range of the first phase change material is different than the melting temperature range of the second phase change material, wherein each first enclosure is adjacent to at least one second enclosure, wherein each first enclosure is within a proximity to the adjacent second enclosure whereby convective heat transfer occurs between the first enclosure and the adjacent second enclosure. In another embodiment, the charged thermal consistency device is placed in substantially direct contact with the human or animal body part or organ for transplantation.

In some embodiments, the predetermined temperature is in a temperature range from about −5° C. to about 85° C., and wherein the melting temperature range of the first phase change material is within 10° C. of the melting temperature range of the second phase change material. In other embodiments, the melting temperature range of the first phase change material is from about 5° C. to about 10° C., and the melting temperature of the second phase change material is from about −2° C. to about 4° C.

In one aspect, the second phase change material comprises one or more inorganic salt, hydrated inorganic salt, or a combination of an inorganic salt and a hydrated inorganic salt. In particular, the at least one inorganic salt of the second phase change material is selected from the group consisting of NaCl, KCl, and CaCl₂. In other embodiments, the second phase change material comprises at least one organic molecule. More particularly, the at least one organic molecule of the second phase change material is selected from the group consisting of a long chain fatty acid, polyol, paraffin, and polyacrylamide.

In some embodiments, the at least one conformable layer of the second enclosure comprises a second flexible polymer. For example, the second flexible polymer is selected from the group consisting of polyamide, polyethylene, polychlorotrifluoroethene, polystyrene, polyethylene terephthalate, and polypropylene. In other embodiments, the at least one conformable layer of the second enclosure comprises a second flexible, thermally conductive material having a thermal conductivity of at least 30 W/mK. In particular, the second flexible, thermally conductive material comprises a metal selected from the group consisting of aluminum and copper.

In some aspects, the thermal consistency device further comprises a first side and a second side, wherein the first side is positioned toward the human or animal body part and the second side is opposite the first side, and wherein the method further comprises placing a thermal transfer fabric over the second side of the thermal consistency device whereby heat is transferred over a larger surface area of the human or animal body as compared to the thermal transfer device in the absence of the thermal transfer fabric.

In some embodiments, the predetermined time is at least 1 hour. In other embodiments, the predetermined time is at least 6 hours.

In other aspects, thermal consistency systems are provided as described above except that the melting temperature range of the phase change material of the first enclosure is from about 30° C. to about 40° C., and the melting temperature range of the phase change material of the second enclosure is from about 37° C. to about 45° C., provided that the melting temperature range of the phase change material of the second enclosure is greater than the melting temperature range of the phase change material of the first enclosure. In other embodiments, the melting temperature range of the phase change material of the first enclosure is from about 65° C. to about 70° C., and the melting temperature range of the phase change material of the second enclosure is from about 75° C. to about 85° C. These embodiments of the thermal consistency systems can be included in a method of applying consistent thermal support to a human or animal body part or to an organ for transplantation within a predetermined temperature range for up to a predetermined time. Such method includes the steps of charging the thermal consistency device; placing the charged thermal consistency device within close proximity to a human or animal body part or an organ for transplantation; and maintaining the charged thermal consistency device within close proximity to the human or animal body part or organ for transplantation for up to the predetermined time; whereby the temperature on at least the surface of the human or animal body part or organ for transplantation is maintained within 2° C. of the predetermined temperature for up to the predetermined time. In other embodiments, the charged thermal consistency device is placed in substantially direct contact with the human or animal body part or organ for transplantation. In yet other embodiments, the predetermined time is at least 1 hour. In still other embodiments, the predetermined time is at least 6 hours.

Other features and advantages of the invention will be understood from the drawings, detailed description, and examples that follow.

### BRIEF DESCRIPTION OF THE DRAWINGS

FIG. 1 depicts an exemplary thermal melting profile for a phase change material (“PCM”). The y-axis represents the temperature of the PCM in degrees Celsius, whereas the x-axis represents the heat added to the system over time. Shown is the solid phase, transition phase, and liquid phase of the exemplary PCM.

FIG. 2A depicts a cross-sectional view of an exemplary enclosure containing a PCM. FIG. 2B depicts a cross-sectional view of an exemplary enclosure containing a PCM. FIG. 2C depicts a top view of an exemplary enclosure containing a PCM.

FIG. 3 depicts an exemplary embodiment of a thermal consistency system containing alternating enclosures filled with PCMs having different melting temperatures.

FIG. 4A depicts an exemplary embodiment of a thermal consistency system containing alternating enclosures filled with solid-liquid PCMs having different melting temperatures. FIG. 4B depicts an exemplary embodiment of a thermal consistency system containing alternating enclosures filled with liquid-solid PCMs having different melting temperatures.

FIG. 5A depicts an exemplary transportation container for use with the thermal consistency systems provided herein. In this embodiment, the transportation container is uncovered. FIG. 5B depicts an exemplary transportation container for use with the thermal consistency systems provided herein. In this embodiment, the transportation container is covered by a lid. FIG. 5C depicts an exemplary thermally protective opening for use with a transportation container.

FIG. 6 depicts an exemplary periodontal chilling device.

FIG. 7 shows a thermal profile for an exemplary thermal consistency system containing alternating enclosures filled with PCMs having different melting temperatures (bottom line) when compared to a control system (top line). The y-axis represents the temperature of the PCM in degrees Celsius, whereas the x-axis represents the time elapsed in minutes.

FIG. 8A shows a thermal profile for an exemplary PCM enclosure containing a PCM having a melting temperature of about 37° C. The top line is the temperature of the PCM enclosure over time. The bottom line is is the temperature of the environment. The y-axis represents the temperature in degrees Celsius, whereas the x-axis represents the time elapsed in minutes. FIG. 8B shows a thermal profile for an exemplary thermal consistency system containing alternating enclosures filled with PCMs having melting temperatures of 37° C. and 45° C. The top line is the temperature of the 37° C. PCM and 45° C. PCM enclosure combination over time. The bottom line is is the temperature of the environment. The y-axis represents the temperature in degrees Celsius, whereas the x-axis represents the time elapsed in minutes.

FIG. 9 shows a thermal profile for an exemplary thermal consistency system containing alternating enclosures filled with PCMs having melting temperatures of 32° C. and 37° C. The top line is the temperature of the 32° C. PCM and 37° C. PCM enclosure combination over time. The bottom line is the temperature of the 32° C. PCM enclosure over time. The y-axis represents the temperature in degrees Celsius, whereas the x-axis represents the time elapsed in minutes.

FIG. 10 shows a thermal profile for the interior of a lockbox over time. The lockbox contains two PCM enclosures each having a melting temperature of about 6° C. The line is the temperature of the lockbox interior over time. The y-axis represents the temperature in degrees Celsius, whereas the x-axis represents the time elapsed in hours.

FIG. 11 shows a thermal profile for the interior of a plastic bin over time. Inside the plastic bin is a cardboard box of twelve test vials and three PCM enclosures. Each enclosure contains a PCM having a melting temperature of about 6° C. The bottom line is the temperature of the plastic bin interior containing the PCM enclosures over time. The top line is the temperature of the control plastic bin. The y-axis represents the temperature in degrees Celsius, whereas the x-axis represents the time elapsed in minutes.

### DETAILED DESCRIPTION

All percentages expressed herein are by weight of the total weight of the composition unless expressed otherwise. All ratios expressed herein are on a weight (w/w) basis unless expressed otherwise.

Ranges may be used herein in shorthand, to avoid having to list and describe each value within the range. Any appropriate value within the range can be selected, where appropriate, as the upper value, lower value, or the terminus of the range.

As used herein, the singular form of a word includes the plural, and vice versa, unless the context clearly dictates otherwise. Thus, the references “a”, “an”, and “the” are generally inclusive of the plurals of the respective terms. For example, reference to “a method” or “an ester” includes a plurality of such “methods”, or “esters.” Likewise the terms “include”, “including”, and “or” should all be construed to be inclusive, unless such a construction is clearly prohibited from the context. Similarly, the term “examples,” particularly when followed by a listing of terms, is merely exemplary and illustrative and should not be deemed exclusive or comprehensive.

The term “comprising” is intended to include embodiments encompassed by the terms “consisting essentially of” and “consisting of”. Similarly, the term “consisting essentially of” is intended to include embodiments encompassed by the term “consisting of.”

The methods and compositions and other advances disclosed herein are not limited to particular equipment or processes described herein because such equipment or processes may vary. Further, the terminology used herein is for describing particular embodiments only and is not intended to limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, the preferred compositions, methods, articles of manufacture, or other means or materials are described herein.

The term “about” refers to the variation in the numerical value of a measurement, e.g., temperature, length, width, height, weight percentage, etc., due to typical error rates of the device used to obtain that measure. In one embodiment, the term “about” means within 5% of the reported numerical value.

The terms “melting point” or “melting temperature” are used interchangeably herein and refer to the temperature at which a solid, such as a solid PCM, changes state from solid to liquid at atmospheric pressure. At the “melting point”, the solid and liquid phase exist in equilibrium.

The terms “freezing point” and “freezing temperature” are used interchangeably herein and refer to the temperature at which a liquid, such as a liquid PCM, changes state from liquid to solid at atmospheric pressure.

The term “R value” as used herein refers to the insulating properties of a material and is expressed as the thickness of the material normalized to the thermal conductivity, and under uniform conditions it is the ratio of the temperature difference across an insulator and the heat flux density through the material measured as R=ΔT/Q_{A}, where Q_{A} is the heat transfer per unit time per unit area.

The term “substantially direct contact” in reference to an enclosure and a human, animal, body part, or object for which thermal support and/or thermal maintenance is desired means that the human, animal, body part, or object is placed within a proximity to the enclosure such that sufficient heat transfer can occur, e.g., conductive or convective heat transfer.

The term “thermal conductivity” as used herein refers to the property of a material to conduct heat.

The term “thermal conduction” as used herein refers to the transfer of heat by microscopic collisions of particles and movement of electrons within an object or body.

The term “thermal convection” as used herein refers to the transfer of heat from one place to another by the movement of fluids or gases.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

The present invention springs in part from the inventor's development of a consistent way to maintain thermal support applied to a part of a human or animal body or to an organ intended for transplantation. Various aspects of the invention utilize a system by which the surface of a body part is maintained within close proximity or in substantially direct contact with an enclosure containing a phase-change material (“PCM”) having a melting point within the temperature range desired by the user. In other aspects, the invention utilizes a system by which an organ that is extracted from the body of an animal or human is maintained, during transport or storage prior to transplantation into the recipient human or animal, within close proximity or in substantially direct contact with an enclosure containing a PCM having a melting point within the temperature range desired by the user. In yet other aspects, the systems, devices, and methods disclosed herein can be used to apply thermal support to a fluid intended for transfusion (e.g., blood and blood products, lactated Ringer's solution, and saline) into a human or animal in order to maintain that fluid within normal physiological temperatures. The devices and methods of the invention are particularly applicable to apply consistent, continuous, and highly controlled temperature gradients directly to a human or animal, organ for transplantation, or fluid for transfusion without the need for the use of mechanical heating or cooling or thermal support provided by chemical reactions (referred to herein as “chemical heating” or “chemical cooling”). In addition, the present devices, systems, and methods provide the desired thermal support while reducing the risk of burns or frostbite and without sacrificing the comfort or mobility of the wearer.

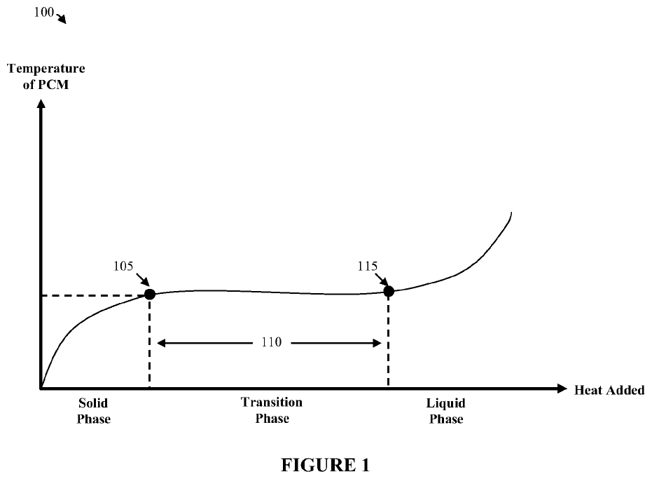

The term phase change material (also referred herein as “PCM”) refer to materials having a large latent heat and high thermal conductivity. PCMs suitable for use in the present devices, systems, and methods should have a melting temperature lying within a predetermined range of operation, melt congruently with minimum subcooling, and be chemically stable. FIG. 1 represents an exemplary thermal melting profile 100 of a PCM as heat is added to the PCM over time. The temperature of a frozen, or solidified, PCM initially rises in response to a rise in the ambient temperature. At point 105, the PCM reaches its melting temperature. As the PCM undergoes melting and absorbing thermal energy in accordance with its latent heat of fusion, the melting profile 100 reveals a stable thermal plateau during the transitional phase 110. During the transitional phase 110, the temperature of the PCM does not rise. Once the PCM is in a liquid state at point 115, the temperature of the PCM again begins to rise in response to the ambient temperature.

The thermal consistency systems and methods disclosed herein may be designed based on a particular desired temperature range, or predetermined temperature, and applied to the body of an animal or human to provide consistent thermal support to the body part in contact with the thermal consistency device as well as to the underlying and surrounding tissue. For example, in some embodiments, the desired temperature may be around the freezing temperature of water or slightly above or below (i.e., −2° C. to 10° C.). Such “cooling” temperatures may alleviate post-operative swelling of muscles and tendons as well as pain, inflammation, and/or swelling associated with muscle and joint injury. The reduction of tissue inflammation and swelling may, in turn, reduce the corresponding release of free radicals that can trigger cell death.

The “cooling” temperatures may also be used to treat a human or animal suffering from hyperthermia (e.g., heat stroke). In these embodiments, it may be desirable to maintain a temperature slightly above freezing to prevent frostbite or other muscular damage caused by prolonged exposure to sub-freezing temperatures. In other embodiments, the PCM material is enclosed in flexible or conformable pouches or bags to increase the surface area of contact between the thermal consistency device and the surface of the animal or human body part.

In another example, the thermal consistency systems, devices, and methods disclosed herein may be designed based on a particular desired temperature range, or predetermined temperature, and placed in close proximity to or in substantially direct contact with an organ intended for transplantation after that organ is removed from the human or animal donor in order to tightly control the temperature of that organ while being stored or transported prior to transplantation into the recipient human or animal. Such an example may also include an insulated container designed to contain contents comprising the organ intended for transplantation in which the organ is placed in substantially direct contact with the thermal consistency system or device. In particular, it may be desired to keep the organ intended for transplant around the freezing temperature of water or slightly above or below (i.e., −2° C. to 10° C.). Such “cooling” temperatures may help prevent organ deterioration and necrosis during the time the organ is stored or transported.

Alternatively, the desired temperature may be about 25° C. to about 50° C. or higher. Such “warming” temperatures may provide soothing relief to an animal or human suffering from orthopedic ailments and the like. Furthermore, thermal consistency devices providing “warming” temperatures may also be used to maintain within normal physiological temperatures certain fluids intended for transfusion into an animal or human, including, but not limited to, blood and blood products (e.g., red blood cells, serum, white blood cells, and platelets), lactated Ringer's solution, and saline. For instance, a thermal consistency device can be placed in substantially direct contact with an intravenous line to maintain the blood or blood products at or near normal animal or human body temperature. Such thermal consistency devices would decrease the likelihood of cardiac arrest and irreversible tissue damage resulting from the transfusion of fluids that have deviated in temperature from acceptable physiological ranges.

Alternatively, thermal consistency devices providing “warming” temperatures can be placed in garments or athletic wear to provide comfort or prevent injury to the wearer when exposed to environmental temperatures below 25° C. In yet another example, the thermal consistency devices providing “warming” temperatures can by used to treat a human or animal suffering from hypothermia. In yet other embodiments, the predetermined temperature range is about 50° C. to about 85° C. or higher, and can be used for deep tissue treatment and the like.

In still other aspects of the invention, the desired temperature may be about −25° C. to about −3° C. Such “freezing” temperatures may be suitable for transporting or storing sperm and eggs for in vitro fertilization procedures or for the cryopreservation of tissues, bodies, and body parts. Thus, for illustrative purposes, the predetermined temperature may be selected from −30° C., −29° C., −28° C., −27° C., −26° C., −25° C., −24° C., −23° C., −22° C., −21° C., −20° C., −19° C., −18° C., −17° C., −16° C., −15° C., −14° C., −13° C., −12° C., −11° C., −10° C., −9° C., −8° C., −7° C., −6° C., −5° C., −4° C., −3° C., −2° C., −1° C., 0° C., 1° C., 2° C., 3° C., 4° C., 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., or higher. Preferably, the predetermined temperature is in a temperature range from about −5° C. to about 85° C.

The PCMs utilized in the systems and methods of this invention are selected based on the predetermined temperature range desired for the particular thermal support. In some embodiments, the PCM is a solid-liquid PCM that has a melting point within the predetermined temperature range to provide thermal support. In other embodiments, the PCM is a liquid-solid PCM that has a melting point (or freezing point) within the predetermined temperature range to provide thermal support. PCMs with melting points over a wide range of temperatures are known in the art, and many are commercially available. In particular embodiments, the PCM melting point is within 10° C. of a predetermined temperature, e.g., within 10° C., 9° C., 8° C., 7° C., 6° C., 5° C., 4° C., 3° C., 2° C., or 1° C. of a predetermined temperature; preferably, the PCM melting point is within 2° C. of a predetermined temperature. In some embodiments, the PCMs with melting points in the range of about −30° C. to about −3° C. are suitable (e.g., cryopreservation). In other embodiments, PCMs with melting points in the range of about −2° C. to about 4° C. are suitable. In a particular embodiment, a PCM with a melting point of about 1° C. is suitable. In other embodiments, PCMs with melting points in the range of about 5° C. to about 10° C. are suitable. In a particular embodiment, a PCM with a melting point of about 6° C. is suitable. In yet other embodiments, PCMs with melting points from about 20° C. to about 30° C. are suitable, preferably about 24° C. or about 29° C. In still other embodiments, PCMs with melting points from about 30° C. to about 50° C. are suitable. In a particular embodiment, a PCM with a melting point of about 37° C. is suitable. For even warmer temperatures, PCMs with melting points of about 55° C. or higher are chosen. Thus, for illustrative purposes, a PCM may be selected having a melting temperature of about −30° C., −29° C., −28° C., −27° C., −26° C., −25° C., −24° C., −23° C., −22° C., −21° C., −20° C., −19° C., −18° C., −17° C., −16° C., −15° C., −14° C., −13° C., −12° C., −11° C., −10° C., −9° C., −8° C., −7° C., −6° C., −5° C., −4° C., −3° C., −2° C., −1° C., 0° C., 1° C., 2° C., 3° C., 4° C., 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., or higher.

In addition, as one skilled in the art would appreciate, some PCMs may have melting temperatures and freezing temperatures that differ slightly due to a phenomenon known as hysteresis. In such a case, the PCM undergoes melting and absorbing thermal energy in accordance with its latent heat of fusion. However, the transition phase may be observed to be a couple of degrees Celsius higher than that of the freezing temperature for the same PCM. In some embodiments, the thermal consistency system is designed using a PCM that undergoes a phase change from liquid to solid. Thus, in some embodiments, PCMs are selected having a freezing temperature of about −30° C., −29° C., −28° C., −27° C., −26° C., −25° C., −24° C., −23° C., −22° C., −21° C., −20° C., −19° C., −18° C., −17° C., −16° C., −15° C., −14° C., −13° C., −12° C., −11° C., −10° C., −9° C., −8° C., −7° C., −6° C., −5° C., −4° C., −3° C., −2° C., −1° C., 0° C., 1° C., 2° C., 3° C., 4° C., 5° C., 6° C., 7° C., 8° C., 9° C., 10° C., 11° C., 12° C., 13° C., 14° C., 15° C., 16° C., 17° C., 18° C., 19° C., 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., or higher.

Examples of PCMs suitable for use in the present invention include, but are not limited to, PURETEMP™ (Entropy Solutions, INC.), PCM-SP™ (RUBITHERM® GmbH), or SAVENRG™ PCM pouch (Rgees, LLC). Other PCMs are well known in the art (see, e.g., Sharma et al., 2009, “Review on Thermal Energy Storage with Phase Change Materials and Applications,” Renewable and Sustainable Energy Reviews 13:318-345). In some embodiments, the PCMs comprise esters of long chain fatty acids (e.g., derived from vegetable materials). In other embodiments, the PCMs comprise polyols, such as glycols, including polyethylene glycols (“PEG”), diols and triols, and mixtures thereof. In yet other embodiments, the PCMs comprise C14 to C34 saturated hydrocarbons. In still other embodiments, the PCMs comprise salts or salt hydrates. In such embodiments, these compounds may be chosen based on the known melting temperature or freezing temperature (see, for example, Table 1). In some embodiments, the PCMs comprise polyols having melting temperatures from about 0° C. to about 65° C. or higher, including hexanediol isomers, PEG 400, PEG 600, PEG 1500, PEG 4000, PEG 6000, PEG 8000, glycerin, or mixtures thereof. As one skilled in the art would appreciate, a PCM composition may comprise a combination of polyols having different melting temperatures to alter the melting temperature of the resultant mixture. Therefore, many different phase change temperatures are possible.

In yet other embodiments, the PCMs comprise salts, eutectic salts, salt hydrates (also referred to herein as “hydrated salts” or “hydrates”), paraffin, high density polyethylene, and naphthalene. In some preferred embodiments, the PCMs comprise sodium chloride (“NaCl”), potassium chloride (“KCl”), calcium chloride (“CaCl₂”), or the hydrate thereof. In another embodiment, the PCM comprises calcium chloride hexahydrate (“CaCl₂*6H₂O”). In yet another embodiment, the PCM comprises water in a three dimensional network of polyacrylamide. For illustrative purposes, a PCM having melting point of about 22° C. may be obtained from a composition comprising NaCl, a PCM having a melting point of about 11° C. may be obtained from a composition comprising KCl, a PCM having a melting point of about 0° C. may be obtained from a composition comprising water in a three dimensional network of polyacrylamide, a PCM having a melting temperature of about 5-6° C. may be obtained from a composition comprising paraffin, a PCM having a melting temperature of about 2-6° C. may be obtained from a composition comprising an inorganic salt, a PCM having a melting point of about 23° C. may be obtained from a composition comprising CaCl₂*6H₂O, and a PCM having a melting point of about 32, ° C. 37° C., 42° C. or 45° C. may be obtained from a composition comprising long chain fatty acids or esters of long chain fatty acids. In some embodiments, PCMs having melting temperatures at about 5° C. or higher may be obtained from compositions comprising organic compounds. For instance, suitable PCMs may comprise saturated hydrocarbons (e.g., paraffin) having carbon chains ranging from 14 carbons to 34 carbons (e.g., a “C14 paraffin” to a “C34 paraffin”), it being understood that the increased length of the carbon chain generally correlates with increasing melting temperatures. In other embodiments, suitable PCMs may comprise a mixture of pentadecane and octadecane having a melting temperature of around 9-10° C.

In some embodiments, PCMs having melting temperatures from about −25° C. to about 0° C. may be obtained from compositions containing inorganic salts in water mixtures, such as Lithium sulfate (“Li2SO4”). In other embodiments, PCMs having melting temperatures from about −15° C. to about 0° C. may be obtained from compositions containing organics, such as diethylene glycol (melting temperature −10° C.).

In other embodiments, PCMs having melting temperatures from about 30° C. to about 50° C. or higher may be obtained from a composition comprising hydrated salts, such as sodium sulfate decahydrate, CaCl₂*6H₂O, sodium carbonate decahydrate, calcium nitrate tetrahydrate, sodium thiosulfate pentahydrate. Other suitable PCMs may comprise eutectic mixtures, such as a Cerrobend eutectic (melting temperature 70° C.) and bismuth/lead/tin (“Bi—Pb—Sn”) eutectic (melting temperature 96° C.) for providing thermal maintenance of an object, such as foodstuff and beverage containers. In yet other embodiments, the PCMs comprise a combination of any of the compounds described herein providing many possible melting temperatures for use in the present thermal consistency systems, methods, and devices. A non-limiting list of exemplary PCMs suitable for use herein is provided in Table 1.

TABLE 1

| | Melting | | | Melting | |
|---|---|---|---|---|---|
| | Temp. | | | Temp. | |
| PCM | (° C.) | Type | PCM | (° C.) | Type |
| Li₂SO₄ (27.9% w/w) + | −23 | I | Formic acid | 7.8 | O |
| H₂O (72.1% w/w) | | | | | |
| Na₂SO₄*10H₂O | 32.4 | SH | C-14 Paraffin | 5.5 | O |
| NaCl*Na₂SO₄*10H₂O | 18 | SH | C-15 Paraffin | 10 | O |
| KAl(SO₄)₂*12H₂O | 91 | SH | C-16 Paraffin | 16.7 | O |
| MgCl₂*6H₂O | 117 | SH | C-17 Paraffin | 21.7 | O |
| LiCH₃COO*2H₂O | 70 | SH | C-18 Paraffin | 28 | O |
| Na₂SiO₃*5H₂O | 72.20 | SH | C-19 Paraffin | 32 | O |
| Na₂HPO₄*12H₂O | 36 | SH | C-20 Paraffin | 36.7 | O |
| CH₃COONa*3H₂O | 46 | SH | C-21 Paraffin | 40.2 | O |
| Na₂S₂O₃*5H₂O | 57 | SH | C-22 Paraffin | 44 | O |
| Mg(NO₃)₂*6H₂O | 89 | SH | C-23 Paraffin | 47.5 | O |
| Ba(OH)₂*8H₂O | 78 | SH | C-24 Paraffin | 50.6 | O |
| CaCl₂*6H₂O | 29 | SH | C-25 Paraffin | 49.4 | O |
| NaOH*H₂O | 64 | SH | C-26 Paraffin | 56.3 | O |
| Mn(NO₃)₂ * 6H₂O + | 15-25 | EU | C-27 Paraffin | 58.8 | O |
| MnCl₂*H₂O | | | | | |
| Cerrelow eutectic | 58 | EU | C-28 Paraffin | 61.6 | O |
| Cerrobend eutectic | 70 | EU | C-29 Paraffin | 63.4 | O |
| Bi + Pb + Sn | 96 | EU | C-30 Paraffin | 65.4 | O |
| eutectic | | | | | |
| Diethylene glycol | −10 | O | C-31 Paraffin | 68 | O |
| Trimethylolethane | 29.8 | O | C-32 Paraffin | 69.5 | O |
| (63% w/w) + H₂O | | | | | |
| (37% w/w) | | | | | |
| azobenzene | 67 | O | C-33 Paraffin | 73.9 | O |
| Glycerin | 17.9 | O | C-34 Paraffin | 75.9 | O |
| Catechol | 104.3 | O | Caprylic acid | 16.3 | FA |
| Quinone | 115 | O | Lauric acid | 44.2 | FA |
| Succinic anhydride | 119 | O | Palmitic acid | 64 | FA |
| Stibene | 124 | O | Capric acid | 32 | FA |
| PEG 600 | 20 | O | Glycolic acid | 63 | FA |
| Methyl | 81 | O | Phenyl acetic | 77 | FA |
| bromobenzoate | | | acid | | |
| azobenzene | 67 | O | Stearic acid | 70 | FA |
| naphthalene | 80 | O | acetamide | 81 | FA |
| Benzamide | 127.2 | O | Methyl | 102 | FA |
| | | | fumarate | | |
| Benzoic acid | 121.7 | O | Pentadecane/ | 9-10 | O |
| | | | octadecane | | |
| | | | mixture | | |

w/w, weight percentage
I, inorganic salt solution
SH, salt hydrate
EU, eutectic
O, organic
FA, fatty acid

In some embodiments, the PCM composition may contain additives. For example, in one embodiment, the PCM mixture may comprise a nucleating agent to prevent supercooling or superheating of the PCM. Suitable nucleating agents include, but are not limited to, talc, alkaline earth metal salts, sodium borate, carbon, TiO₂, Copper, Aluminum, Na₂SO₄, SrSO₄, and K₂SO₄. In other embodiments, the PCM mixture may comprise a thickener to prevent subcooling due to phase segregation (e.g., phase segregation of hydrated salts). Suitable thickening agents include, but are not limited to, a superabsorbent polymer made from an acrylic acid copolymer and carboxymethyl cellulose. Suitable thickening agents may be added to the PCM mixture in a range from about 1% by weight to about 10% by weight, preferably from about 2% by weight to about 5% by weight. Thickening and nucleating agents are described in detail in Farid et al., Energy Convers Mgmt 45:1597-1615 (2004), the contents of which is incorporated by reference herein in its entirety.

In some embodiments, one thermal consistency device may be placed on an animal or human or an organ for transplantation. In other embodiments, more than one thermal consistency device may be placed on the animal or human or an organ for transplantation. In such embodiment, the thermal consistency devices can be selected based on the same or different predetermined temperatures. For example, it may be desirable to use a combination of thermal consistency devices comprising PCMs having different melting temperatures to provide thermal support at both warmer and cooler temperatures. Thermal consistency devices that comprise PCMs having melting temperatures within 2° C. of a predetermined temperature range from about 0° C. to about 10° C. can be placed in some areas of the human or animal body, while thermal consistency devices that comprise PCMs having melting temperatures within 2° C. of a predetermined temperature range from about 37° C. to about 50° C. can be placed against other areas of the animal or human body to provide relief. In yet other embodiments, thermal devices comprising PCMs having melting temperatures within 2° C. of a predetermined temperature range from about −2° C. to about 36° C., preferably about 0° C. to about 25° C., more preferably about 1° C. to about 10° C. may be used in combination with thermal consistency devices comprising PCMs having melting temperatures within 2° C. of a predetermined temperature range from about 25° C. to about 55° C., preferably about 30° C. to about 45° C., more preferably about 35° C. to about 40° C. In some embodiments, a thermal consistency system or device may comprise sets of three or more PCM enclosures containing PCMs with different melting temperatures, each within about 10-15° C. of the adjacent PCM (e.g., about 37° C., about 45° C., and about 50° C.).

The PCM composition typically is disposed within an enclosure. While the enclosure can be of any size or shape, it is preferable that the enclosures have a large enough surface area to effectively maintain the thermal support on the body part of an animal or human, but small enough so that the enclosures do not cause discomfort or become burdensome for the wearer. In addition, the enclosures of the present invention can be easily slipped in and out of garments (e.g., mittens, gloves, socks, sports wear, leg warmers, arm warmers, headgear), medical devices (e.g., casts, bandages, cervical collars), or equipment (e.g., seat warmers, wet suits, dry suits, insulated containers). Furthermore, such garments, medical devices, and equipment can be specially designed or altered to hold the enclosures of the present invention in place. For example, active wear can be specially designed to comprise compartments for quickly and easily inserting the enclosures of the present invention. Thus, the wearer can quickly change from warmer to cooler enclosures, and vice versa, depending on the environmental conditions or desired temperature. The enclosures of the present devices and systems can also be used in combination with a thermal transfer fabric. For example, a thermal consistency device can be employed utilizing one or more enclosures providing “cooling” temperatures or “warming” temperatures (or, alternatively, at least one enclosure providing “cooling” temperatures in combination with at least one enclosure providing “warming” temperatures) that is affixed to the body part of a human or animal. Then, the thermal transfer fabric (e.g., fabric used in combination with a flexible aluminum backing) may be placed over the enclosures and in contact with another area on the human or animal in order to draw heat away from or provide heat to that area.

Accordingly, in some embodiments, the enclosure is a square or rectangular shape having dimensions having a length ranging from about 0.5 inches (1.27 cm) to about 10 inches (25.4 cm) or more and a width ranging from about 0.5 inches (1.27 cm) to about 5 inches (12.7 cm) or more, preferably about 0.75 inches (1.905 cm) to about 5 inches (12.7 cm) in length and about 0.75 inches (1.905 cm) to about 3 inches (7.62 cm) in width, more preferably about 1.5 inches (3.81 cm) to about 3 inches (7.62 cm) in length and about 1.0 inch (2.54 cm) to about 2.0 inches (5.08 cm) in width, most preferably about 1.5 inches (3.81 cm) in length and about 1.5 inches (3.81 cm) in width or about 3.0 inches (7.62 cm) in length and about 1.5 inches (3.81 cm) in width. In some embodiments, the enclosures have a thickness (or height) ranging from about 0.2 inches (0.508 cm) to about 2.0 inches (0.508 cm) or more, preferably about 0.25 (0.635 cm) inches to about 1 inch (2.54 cm), most preferably about 0.5 inches (1.27 cm). In a preferred embodiment, the enclosures are in the shape of a pouch.

The enclosure(s) for the PCM can be made of any material, as long as the material is capable of enclosing the PCM for at least the predetermined time and any additional time needed to charge or equilibrate the PCM at the desired temperature range. Accordingly, the material comprising the enclosure should be substantially inert to the PCM; i.e., not reactive with or degraded by the PCM. Additionally, in some embodiments, the enclosures of the present invention are made out of a conformable and flexible material, such that close contact between the enclosure and the surface of the body part or organ is better achieved. In certain embodiments, the enclosures are comprised of one or more layers of conformable or flexible material. For example, the enclosures can be made of a flexible polymer, including polyamide (e.g., nylon), polyethylene (e.g., high density polyethylene), polychlorotrifluoroethene, polystyrene, polyethylene terephthalate, and polypropylene.

In some embodiments, the enclosure is placed in substantially direct contact with an intravenous line for, e.g., transfusion of blood or blood products. In such embodiments, the enclosure may comprise a conformable or flexible polymer, including polyamide (e.g., nylon), polyethylene (e.g., high density polyethylene), polychlorotrifluoroethene, polystyrene, polyethylene terephthalate, and polypropylene. In one embodiment, the enclosure is wrapped around the intravenous line. In a preferred embodiment, the enclosure is wrapped around the intravenous line in close proximity to the injection point in the animal or human body to provide thermal support to the blood or blood products as they enter the animal or human body. The predetermined temperature of the PCM material will depend on the normal body temperature of the animal or human receiving the transfusion. For instance, normal human body temperature is typically about 36° C. to about 38° C., whereas typical body temperature for horses is about 37° C. to about 39° C. and dogs is about 38° C. to about 40° C. In some embodiments, the enclosure is placed inside a container (e.g., a hinged box) through which the intravenous line is run.

In some embodiments of the present invention, the enclosures comprise more than one layer. In a particular embodiment, the enclosures comprise at least two layers. It is preferable that each layer is conformable and made of flexible materials for the reasons described above. In some embodiments, the enclosures comprise at least one layer made from a thermally conductive material, preferably one having a thermal conductivity of at least 30 watts per meter Kelvin (“W/mK”), more preferably one having a thermal conductivity of at least 40, 50, 60, 70, 80, 90, 100, 110, 120, 130, 140, 150, 160, 170, 180, 190, 200, 210, 220, 230, 240, 250, 260, 270, 280, 290, 300 or more W/mK, most preferably having a thermal conductivity of at least 250 W/mK. In some embodiments, the thermally conductive material comprises aluminum. In other embodiments, the thermally conductive material comprises copper. In a particular embodiment, the thermally conductive material is aluminum foil and forms a conformable layer of the enclosure. The thermally conductive layer may be the innermost layer in a multi-layered enclosure. Alternatively, the thermally conductive layer may be the outermost layer in contact with an object, body part, or organ. In yet other embodiments, the enclosures are comprised of at least three layers, wherein two of the layers are made of a flexible polymer, whereas the third layer comprises the thermally conductive material. In such embodiments, the thermally conductive material may be the innermost layer, the middle layer, or the outermost layer. In yet other embodiments, the enclosure(s) comprise more than three layers.

In some embodiments, the enclosures containing the PCM must be charged prior to use. For example, if the PCM is to be used in a frozen, or solid state (e.g., a solid-liquid PCM having a melting temperature around 0° C.), then the enclosure(s) containing the PCM is placed in an environment below the melting temperature to allow the PCM material to solidify. In other embodiments, the PCM material is to be used in a melted, or liquid state (e.g., a liquid-solid PCM having a melting temperature around 37° C.). In such an embodiment, the enclosure(s) containing the PCM is placed in an environment above the melting temperature to allow the PCM material to liquefy. Furthermore, the charged PCMs may take a period of time (e.g., about 1 minute to about 2 hours) to normalize to the desired temperature, especially when using another PCM enclosure as a “booster”. For instance, disclosed herein are thermal consistency systems containing multiple PCM enclosures, wherein one PCM enclosure acts as a “booster” for the other PCM enclosure. In some embodiments, the “booster” PCM enclosure increases the temperature of the enclosure to be placed in substantially direct contact with an animal, human, or object to a temperature greater than 2° C. of the predetermined temperature. In other embodiments, the “booster” PCM enclosure decreases the temperature of the enclosure to be placed in substantially direct contact with an animal, human, or object to a temperature less than 2° C. of the predetermined temperature. However, it is well within the purview of the skilled artisan to monitor the thermal consistency system until it reaches the desired temperature prior to placing it in substantially direct contact with the animal, human, or object.

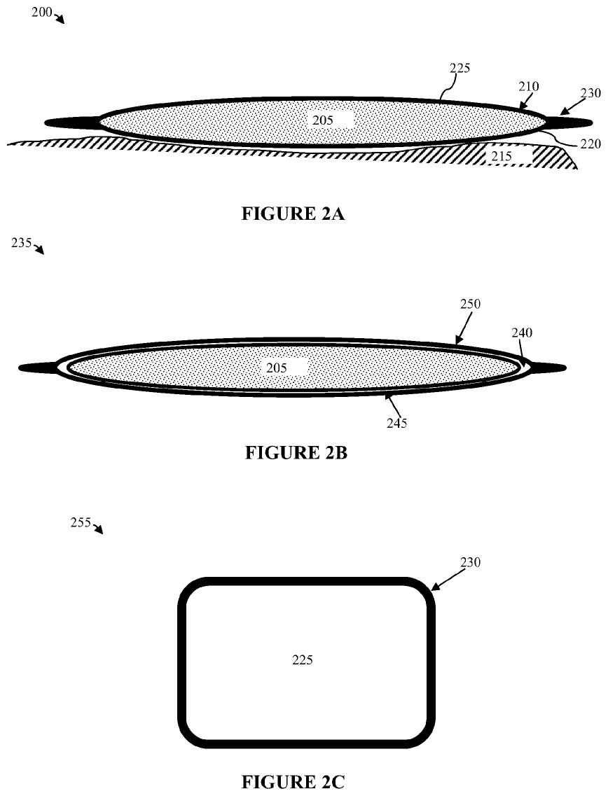

FIG. 2A depicts a cross-sectional view of a non-limiting example of an enclosure containing a PCM. The enclosure 200 comprises a conformable layer 210, which can be a flexible polymer or flexible, thermally conductive material. In certain embodiments, conformable layer 210 is made of a flexible polymer, including polyamide (e.g., nylon), polyethylene (e.g., high density polyethylene), polychlorotrifluoroethene, polystyrene, polyethylene terephthalate, and polypropylene. In other embodiments, conformable layer 210 is made of a thermally conductive material such as a metal foil. The edges of the enclosures 230 are sealed to prevent leaks or contamination of the PCM 205. This particular depiction of enclosure 200 reveals a top side 225 and a bottom side 220. The bottom side 220 is brought to within close proximity to object 215, which is preferably a body part of a human or animal or an organ to be transplanted. In a particular embodiment, the bottom side 220 is in substantially direct contact with object 215.

In some embodiments, the enclosure is comprised of multiple conformable layers. As shown in FIG. 2B, enclosure 235 comprises three conformable layers that include an innermost layer 245, a middle layer 240, and an outermost layer 250. In certain embodiments, innermost layer 245 is made of a flexible polymer, including polyamide (e.g., nylon), polyethylene (e.g., high density polyethylene), polychlorotrifluoroethene, polystyrene, polyethylene terephthalate, and polypropylene. In such embodiments, middle layer 240 may be made of a thermally conductive material and outermost layer 250 may be comprised of a flexible polymer. Alternatively, all three layers 245, 240, and 250 may be made of a flexible polymer.

In one particular embodiment, enclosure 235 may be a pouch that is 1 inch (2.54 cm) wide by 2.5 inches (6.35 cm) long and comprising an innermost layer 245 made of high-density polyethylene, a middle layer 240 made of polyethylene terephthalate, and an outmost layer 250 made of nylon 6-6. In an alternative embodiment, innermost layer 245 is made of a thermally conductive material such as a metal foil. In yet other embodiments, the outermost layer 250 is made of a thermally conductive material. In still other embodiments, all three layers 245, 240, and 250 may be made of thermally conductive materials. FIG. 2C depicts a top view of an enclosure 255 showing a top side 225. In a preferred embodiment, enclosures 200, 235, and 255 are sealed pouches containing PCM 205. The enclosures of the present systems, devices, and methods are sealed by any means known in the art, including, but not limited to heat-sealing with a manual impulse laminator.

In one embodiment, a method for applying consistent thermal support to a body part of a human or animal or organ for transplantation is disclosed. In such an embodiment, a thermal consistency device or system is provided. The thermal consistency device or system may be comprised of at least one enclosure containing a PCM having a melting temperature within 10° C. of a predetermined temperature, preferably within 5° C. of a predetermined temperature, most preferably within 2° C. of a predetermined temperature. The predetermined temperature depends upon the particular thermal support that is desired. For example, for treating muscle injuries (e.g., strained or pulled muscles), reducing swelling, and the like, the predetermined temperature range may be from about −5° C. to about 25° C., preferably from about 0° C. to about 20° C., more preferably from about 1° C. and 10° C., most preferably from about 2° C. to about 6° C. On the other hand, for treating muscle aches, preventing muscle or ligament strains prior to physical activity, keeping warm in environmental conditions below comfortable room temperatures, the predetermined temperature range may be from about 20° C. to about 60° C., preferably from about 30° C. to about 50° C., most preferably from about 30° C. to about 40° C. In other embodiments, thermal support for deep tissue treatment and the like is desired requiring a predetermined temperature range from about 50° C. to about 85° C., preferably from about 60° C. to about 75° C., more preferably from about 65° C. to 70° C.

In one embodiment, the enclosures of the thermal consistency device or system are charged prior to use. In such an embodiment, the charged enclosures of the thermal consistency system are then placed to within close proximity to the body part of a human or animal or an organ for transplantation. In yet other embodiments, the enclosures of the thermal consistency device or system are placed in substantially direct contact with the surface of the body part of the human or animal or organ for transplantation to allow consistent and efficient thermal support via thermal conduction. The enclosures of the thermal device are system are maintained in close proximity to or in substantially direct contact with the surface of the body part of the human or animal or organ for transplantation for up to the predetermined time to maintain the surface temperature of the body part within 2° C. of the predetermined temperature for up to the predetermined time.

The predetermined time can be any period of time during which it is desired to maintain the precise temperature range without mechanical or chemical heating or cooling. For some embodiments, the predetermined time is typically a few minutes, ranging up to several hours. For example, the predetermined time may be 1, 2, 3, 4, 5, 6, 7, 8, 9, 10 minutes or more. In other examples, the predetermined time may be 10, 20, 30, 40, 50 minutes or up to an hour. For other embodiments, the predetermined time is up to about 1, 2, 3, 4, 5, 6, 7, 8, 9, 10, or 11 hours. In yet other embodiments, the predetermined time is longer, e.g., 15, 18, 21, or 24 hours. In another aspect of the invention, at least two enclosures comprising PCMs having different melting temperatures are used in combination. In particular, alternating enclosures containing PCMs with melting temperatures differing by 5° C. or more can be used in combination. In some embodiments, the alternating enclosures contain PCMs with melting temperatures differing by 10° C. or more. In a preferred embodiment, the alternating enclosures contain PCMs with melting temperatures differing by less than 30° C., more preferred less than 20° C., even more preferred less than 10° C., most preferred about 5° C. In some embodiments, a thermal consistency system comprises at least one first enclosure containing a PCM having a melting temperature within 5° C. of the predetermined temperature, preferably within 3-4° C. of the predetermined temperature, most preferably within 2° C. of the predetermined temperature, and at least one second enclosure containing a PCM having a melting temperature range that is different from the PCM of the first enclosure. In such an embodiment, the PCM of the second enclosure is within 30° C. of the predetermined temperature, preferably within 20° C. of the predetermined temperature, most preferably within 15° C. of the predetermined temperature.

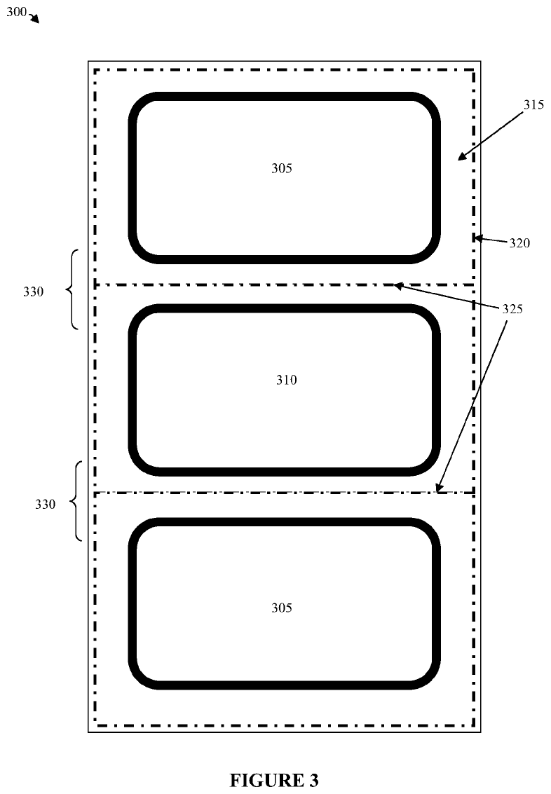

Depicted in FIG. 3 is an exemplary embodiment of a thermal consistency system 300 utilizing alternating PCMs. Thermal consistency system 300 is comprised of three enclosures containing PCMs having two different melting temperatures. For example, enclosure 305 may comprise a PCM having a melting temperature of about 1° C., whereas enclosure 310 may comprise a PCM having a melting temperature of about 6° C. When enclosures 305 and 310 are brought to within a close proximity 330, convective heat transfer occurs between the two enclosures. When using solid-liquid PCMs, the cooler PCM acts as a “booster” for the warmer PCM and extends the period of time that the warmer PCM is in its transition phase. In other words, the warmer PCM takes longer to transition from a solid to a liquid. Thus, the combination of the two PCMs can maintain the thermal support of an object, body part, organ, drug, etc., for a longer period of time a compared to either PCM enclosure alone. Alternating enclosures 305 and 310 can be held into place using an outer encasement 315 made of a flexible polymer material, including polyamide (e.g., nylon), polyethylene (e.g., high density polyethylene), polychlorotrifluoroethene, polystyrene, polyethylene terephthalate, and polypropylene. The thermal consistency system 300 may then be sealed around the edges 320 using any means known in the art, including, but not limited to, heat-sealing with a manual impulse laminator. The alternating enclosures 305 and 310 may be kept separated by a separator element 325, which can be comprised of an insulating material or a non-insulating material. In some embodiments, the separator element 325 is water. In other embodiments, the separator element 325 is air or other gas. As such, the thermal transfer between enclosures 305 and 310 occurs by convection rather than conduction.

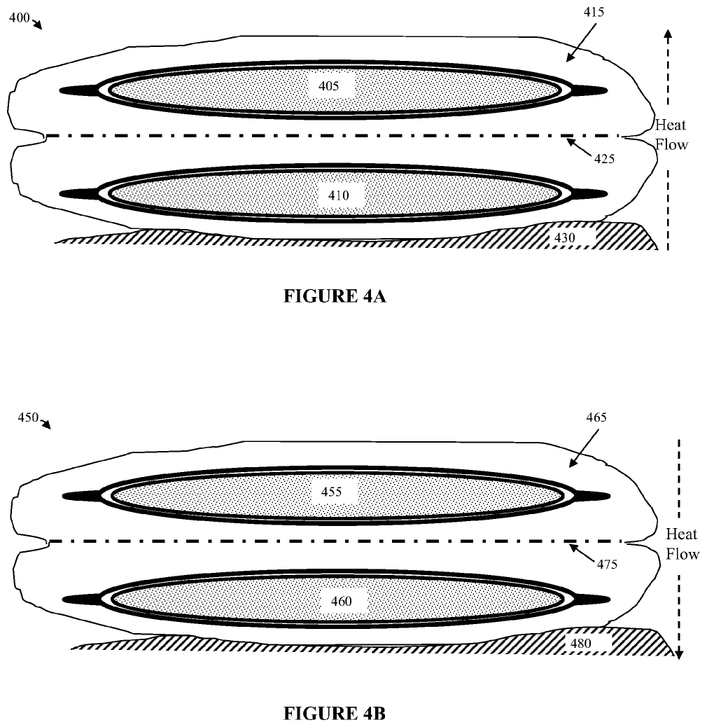

Depicted in FIG. 4A, is an alternative arrangement of a thermal consistency system utilizing alternating enclosures containing solid-liquid PCMs having different melting temperatures. Thermal consistency system 400 is comprised of two enclosures containing solid-liquid PCMs having two different melting temperatures. For example, enclosure 405 may comprise a PCM having a melting temperature of about 1° C., whereas enclosure 410 may comprise a PCM having a melting temperature of about 6° C. Alternating enclosures 405 and 410 can be held into place using an outer encasement 415 made of a flexible polymer material, including polyamide (e.g., nylon), polyethylene (e.g., high density polyethylene), polychlorotrifluoroethene, polystyrene, polyethylene terephthalate, and polypropylene. The alternating enclosures 405 and 410 may be kept separated by a separator element 425, which can be comprised of an insulating material or a non-insulating material. In some embodiments, the separator element 425 is water. In other embodiments, the separator element 425 is air or other gas. As such, the thermal transfer between enclosures 405 and 410 occurs by convection rather than conduction. The PCMs in FIG. 4A are arranged such that the warmer PCM enclosure 410 (i.e., the PCM enclosure containing the PCM with the higher melting temperature) is placed in substantially direct contact with surface 430. In such an arrangement, heat from the warmer PCM enclosure 410 will transfer to the cooler PCM enclosure 405 (i.e., the PCM enclosure containing the PCM with the lower melting temperature), which will act as a “booster” for the warmer PCM enclosure 410 by keeping it in its transitional phase for a longer period of time. Since the warmer PCM takes longer to melt, the thermal support of surface 430 is extended.

In some embodiments, a thermal consistency system utilizing alternating enclosures containing PCMs having different melting temperatures is provided, in which the first enclosure may comprise a liquid-solid PCM having a melting temperature in the range from about 25° C. to about 75° C. and the second enclosure may comprise a PCM having a melting temperature in the range from about 25° C. to about 85° C., provided that the melting temperature of the PCM of the first enclosure is different than the melting temperature of the PCM of the second enclosure. In a preferred embodiment, the melting temperature of the PCM of the first enclosure is within 15° C. of the melting temperature of the PCM of the second enclosure. When using liquid-solid PCMs, the warmer PCM acts as a “booster” for the cooler PCM and extends the period of time that the cooler PCM is in its transition phase. In other words, the cooler PCM material takes longer to transition from a liquid to a solid. Thus, the combination of the two PCMs can maintain the thermal support of an object, body part, organ, drug, etc., for a longer period of time a compared to either PCM enclosure alone.

For instance, thermal consistency system 450 depicted in FIG. 4B is comprised of two enclosures containing liquid-solid PCMs having two different melting temperatures. For example, PCM enclosure 455 may comprise a PCM having a melting temperature of about 80° C., whereas PCM enclosure 460 may comprise a PCM having a melting temperature of about 68° C. Alternating enclosures 455 and 460 can be held into place using an outer encasement 465 made of a flexible polymer material, including polyamide (e.g., nylon), polyethylene (e.g., high density polyethylene), polychlorotrifluoroethene, polystyrene, polyethylene terephthalate, and polypropylene. The alternating enclosures 455 and 460 may be kept separated by a separator element 475, which can be comprised of an insulating material or a non-insulating material. In some embodiments, the separator element 475 is water. In other embodiments, the separator element 475 is air or other gas. As such, the thermal transfer between enclosures 455 and 460 occurs by convection rather than conduction. The PCMs in FIG. 4B are arranged such that the cooler PCM enclosure 460 (i.e., the PCM enclosure containing the PCM with the lower melting temperature) is placed in substantially direct contact with surface 480. In such an arrangement, heat from the warmer PCM enclosure 455 (i.e., the PCM enclosure containing the PCM with the higher melting temperature) will transfer to the cooler PCM enclosure 460, which will act as a “booster” for the cooler PCM enclosure 460 by keeping it in its transitional phase for a longer period of time. Since the cooler PCM takes longer to freeze, the thermal support of surface 480 is extended.

In other embodiments, a thermal consistency system utilizing combinations of three or more enclosures containing PCMs having different melting temperatures is placed in substantially direct contact with an animal, human, or object. In such embodiments, one of the PCM enclosures is placed in substantially direct contact with the animal, human, or object with the other two acting as “boosters” for the PCM enclosure closest to the animal, human, or object as described above.

In yet other embodiments, a thermal consistency system utilizing alternating enclosures containing PCMs having different melting temperatures is placed in substantially direct contact with a drug or medical supplement that must be kept within a narrow temperature range to avoid degradation during transport. For instance, an erythropoietin (“EPO”) derivative (i.e., carbamylated erythropoietin) is used in the treatment of certain diseases, such as skeletal muscular atrophy. Carbamylated EPO is very expensive must be kept within a narrow temperature range from about 2° C. to about 6° C. Thus, in some embodiments, a thermal consistency system having at least one set of two PCM enclosures with melting temperatures of about 1° C. and about 5-6° C. are placed in substantially direct contact with a carbamylated EPO. The thermal consistency device is positioned such that the warmer PCM enclosure (i.e., melting temperature of about 5-6° C.) is in substantially direct contact with the drug, while the cooler PCM enclosure is adjacent the side of the warmer PCM enclosure opposite that of the drug. In this arrangement, the cooler PCM enclosure can extend the transition phase time period for the warmer PCM enclosure (i.e., act as a “booster”) without touching the drug while still enabling the thermal consistency system to provide consistent thermal support for the drug for longer periods of time. The thermal consistency system and drug can be further enclosed within a box, such as an art standard lock box having suitable dimensions to enclose the drug and PCM enclosures, for transport.

In other embodiments, PCM enclosures of the present invention are placed in close proximity to the wet ice or dry ice and act as a “booster” for the wet ice or dry ice thereby extending the period of time of thermal support to an animal, human, or object. For instance, the PCM enclosures can be used with wet ice or dry ice in refrigerators or freezers for storing medicinals or medical samples and can functional as a back-up feature in the event of a power failure thereby keeping the temperature sensitive contents of the refrigerator or freezer from being destroyed.

In another embodiment, a thermal consistency system utilizing alternating enclosures containing PCMs having different melting temperatures is placed in substantially direct contact with the hands and feet of a patient undergoing surgery in order to provide thermal support to the extremities of the patient. Appropriate melting temperatures of the PCMs can be chosen to maintain the hands and feet of the patient within the normal range of human body temperature. For instance, in a preferred embodiment, the cooler PCM enclosure contains a PCM with a melting temperature within about 2° C. of about 37° C. (e.g., a PCM having a melting temperature of about 35° C.) and the warmer PCM enclosure contains a PCM with a melting temperature greater than that of the cooler PCM, but within about 10-15° C. of the cooler PCM (e.g., a PCM having a melting temperature of about 45° C.). The warmer PCM acts as a “booster” for the cooler PCM thus extending the time that the cooler PCM is in its transition phase. Thus, the combination of the two PCMs can provide thermal support to the hands and feet and maintain the hands and feet at about 35-37° C. for a longer period of time than a single PCM enclosure.

The skin of a canine tends to be especially sensitive to high temperatures and thus the application of thermal support to the animal's skin requires careful and consistent temperature regulation. Thus, in another embodiment, a thermal consistency system utilizing alternating enclosures containing PCMs having different melting temperatures is placed in substantially direct contact with the body of a canine to regulate the body temperature being applied to the canine's skin. In one non-limiting exemplary embodiment, the cooler PCM enclosure contains a PCM comprising long chain fatty acids having a melting temperature of about 32° C., and the warmer PCM enclosure contains a PCM comprising long chain fatty acids having a melting temperature of about 37° C. In such embodiment, the cooler PCM enclosure is placed against the canine's body with the warmer PCM placed in close proximity to the opposite side of the cooler PCM enclosure to act as a “booster” for the cooler PCM. In another non-limiting exemplary embodiment, the cooler PCM enclosure contains a PCM comprising hydrated salts having a melting temperature of about 34° C., and the warmer PCM enclosure contains a PCM comprising long chain fatty acids having a melting temperature of about 37° C. In such embodiment, the cooler PCM enclosure is placed against the canine's body with the warmer PCM placed in close proximity to the opposite side of the cooler PCM enclosure to act as a “booster” for the cooler PCM. To increase the time of the transition phase of the cooler PCM enclosure to an even greater extent, the warmer PCM enclosure can be removed just prior to the freezing of the PCM in the warmer enclosure and replaced with a charged PCM enclosure containing PCM having substantially the same melting temperature.

The thermal consistency system utilizing alternating enclosures containing PCMs having different melting temperatures can be applied to a variety of apparel for, e.g., sports, scuba diving, mountaineering, and the like. For instance, professional baseball players, such as pitchers, tend to wear warm-up jackets prior to games and in between innings to keep the muscles of their arms from tightening up. Therefore, in one embodiment, a jacket is provided that contains an inner lining in the arms comprising a PCM that is within about 2-10° C. of a desired thermal support temperature. Further, the outer lining of the arms of the jacket comprises a plurality of pockets of suitable size to allow for the insertion of warmer PCM enclosures containing PCMs with melting temperatures above that of the inner lining PCM. The warmer PCM enclosures act as a “booster” for the inner lining PCMs and can easily be replaced just prior to freezing to increase the thermal maintenance time of the inner lining PCMs. Similarly, wetsuits and climbing jackets can utilize the thermal consistency systems to provide prolonged thermal support to the wearer for protection from the cold environments of the deep sea or high elevations.

In some parts of the world, communities are located several hours or more from the nearest medical care facility. Furthermore, such communities may be located in harsh environments, such as at very high elevations, and without usable roads or accessibility to motorized transport. Therefore, transportation of sick individuals to the medical care facility may require walking for several hours or by using animal-drawn carriages. In very hot or very cold environments, poor regulation of the sick or injured individual's body temperature during the several hour trip to the hospital may result in worsening of the individual's condition. This is especially true for young children and infants. Thus, in some embodiments, provided herein is a child carrier device that incorporates the PCM enclosures; preferably, the device incorporates the thermal consistency system utilizing alternating enclosures containing PCMs having different melting points. The child carrier device comprises a transportation container in which is disposed at least one PCM enclosure and/or at least one thermal consistency system. The child or infant sits or lies down in the transportation container and the PCM enclosures or thermal consistency systems are placed in substantially direct contact with one or more body parts to provide thermal support to the child or infant during transportation.

The PCM enclosures are preferably within about 2-10° C. of a predetermined temperature; more preferably within about 2° C. of the predetermined temperature. In preferred embodiments, the predetermined temperature is at or slightly below the normal body temperature of a human child or infant (about 37° C.). As such, in the preferred embodiment, the PCM enclosures may contain PCMs having melting points/freezing temperatures within about 2-10° C. of about 35-37° C. Any PCMs meeting these criteria, including any of the PCMs described above, are suitable for use in the transportation container. More preferably, the PCMs will be selected from non-toxic materials, such as long chain fatty acids. When using a “booster” PCM enclosure that contains a PCM having a higher melting temperature than that of the PCM enclosure that will be placed in close proximity to or in substantially direct contact with the young child or infant, it is preferable to ensure that the PCM enclosure nearest the child or infant is not greater than about 2-5° C. of the predetermined temperature prior to use. Thus, it may be desirable to monitor the PCMs for a short period of time to ensure that they reach the predetermined temperature before placing into the transportation container and/or prior to the child or infant entering the transportation container.

In some embodiments, the transportation container will contain one or more thermal consistency system having pairs of warmer and cooler PCM enclosures as described in detail above. For instance, in one preferred embodiment, the thermal consistency system includes a cooler PCM enclosure containing a PCM having a melting temperature of about 37° C. and a warmer PCM enclosure containing a PCM having a melting temperature of about 40° C. The thermal consistency system is then placed in the transportation container such that a first surface of the cooler PCM enclosure is in substantially direct contact with one or more body parts of the child or infant whereas the warmer PCM enclosure is at the second surface of the cooler PCM enclosure (i.e., the cooler PCM enclosure is positioned between the child and the warmer PCM enclosure). The warmer PCM enclosure will act as a “booster” for the cooler PCM thereby extending the time period that the cooler PCM is in its transition phase.

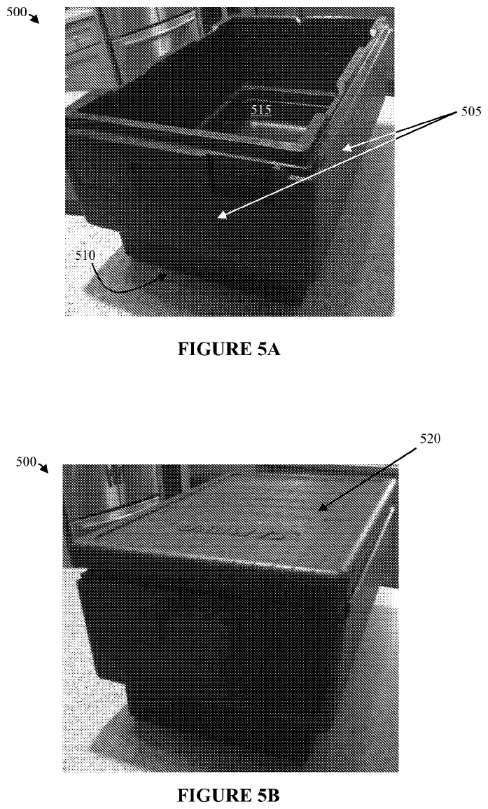

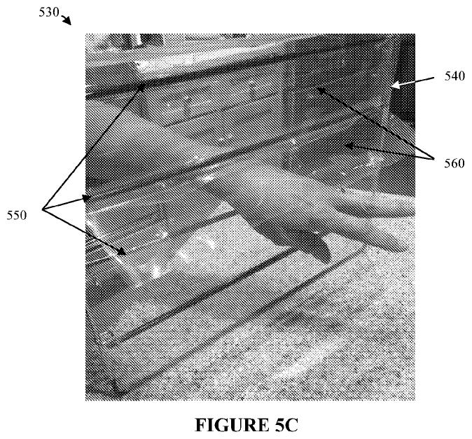

The transportation container can be any size or shape so long as it is large enough for the child or infant to sit or lie down inside the transportation container. For instance, the transportation container can be a box having an inner volume in the range from about 5,000 in³ (about 0.082 m³) to about 10,000 in³ (about 0.16 m³), or more. FIG. 5A and FIG. 5B depict a non-limiting exemplary embodiment of the transportation container 500. As shown in FIG. 5A, the transportation container 500 has four side walls 505 and a bottom 510 that forms an inner volume 515 in which a child or infant can sit or lie. FIG. 5B depicts the transportation container with a top cover or lid 520 that can be placed over the inner volume 515. The dimensions of the transportation container can be of any length, width, and height so long as the transportation container is large enough to fit the child or infant and the PCM enclosures. For instance, in some embodiments, each of the length, width, and height of the transportation container is from about 300 cm to about 500 cm, or more, e.g., about 300 cm, 310 cm, 320 cm, 330 cm, 340 cm, 350 cm, 360 cm, 370 cm, 380 cm, 390 cm, 400 cm, 410 cm, 420 cm, 430 cm, 440 cm, 450 cm, 460 cm, 470 cm, 480 cm, 490 cm, 500 cm, or more. For instance, the transportation carrier 500 in FIG. 5A and FIG. 5B has the dimensions of about 24 in. (about 393.3 cm)×about 20 in. (about 327.7 cm)×about 12 in. (about 196.6 cm).

It may be desirable that the transportation container provide additional insulation further thermal support to the child or infant during transportation. Thus, in some embodiments, the transportation container is made of an insulating material having an R value in the range from 2 to 50; preferably from 5-30. In one exemplary embodiment, the insulated container is a box comprising polystyrene having an R value of 18-20. In some embodiments, access to the child or infant during the transport is necessary for, e.g., feeding, hydration, checking vitals, and the like. Opening the lid of the transportation container would result in much of the thermally regulated air escaping (e.g., loss of warm air). Therefore, to enhance the thermal regulation properties of the transportation container and the PCM enclosures within, it may be desirable to include an thermally protective opening, such as a plastic door curtain, that is positioned over the inner volume of the transportation container. The top cover or lid is then placed over the thermally protective opening, which can be constructed of any suitable insulating material. FIG. 5C depicts an exemplary embodiment of a thermally protective opening 530. Thermally protective opening 530 includes a metal frame 540 with metal rods 550 on which are disposed plastic strips 560. Plastic strips 560 provide slits to allow an arm to push the plastic strips 560 aside temporarily to access the child or infant while less than about 10% of the surface of the thermally protective opening 530 exposes the inner volume of the transportation container to the outer environment. Thus, the thermally protective opening prevents loss of large amounts of thermally regulated air from escaping the transportation container.

Also provided herein are apparel having pockets for the placement of PCM enclosures. In some embodiments, the apparel is athletic apparel including, but not limited to football helmets, warm-up jackets, climbing coats, wetsuits, and the like. In such embodiments, the apparel will have a liner or a plurality of pockets for the insertion of PCM enclosures. The PCM enclosures can contain PCMs having a variety of melting or freezing temperatures for applying thermal support. In some embodiments, the PCM enclosures inserted into the apparel will contain PCMs having the same melting/freezing temperatures. In other embodiments, the PCMs will have different melting/freezing temperatures. For instance, it may be desirable for an athlete to applying cooling temperatures to one part of the body and warming temperatures other other parts of the body. Furthermore, it may be desirable for an athlete to applying warming temperatures to one part of the body and even warmer temperatures other other parts of the body. Thus, the apparel, e.g., a jacket, may comprise pockets throughout for the placement of PCM enclosures of varying melting/freezing temperatures. In one non-limiting exemplary embodiment, a warm-up jacket is provided comprising a plurality of pockets along the arms of the jacket wherein warming and/or cooling PCM enclosures can be inserted for thermal support and easily removed or replaced as desired. In another non-limiting exemplary embodiment, a football helmet is provided wherein a plurality of pockets are placed on the inside of the helmet wherein warming and/or cooling PCM enclosures can be inserted for thermal support and easily removed or replaced as desired.

In another embodiment, medical devices, including, but not limited to, cervical collars, air casts, splints, braces, and the like, are provided that comprise one or more pockets or sleeves for the placement of PCM enclosures of the present invention. For instance, an individual who has had a traumatic neck injury may require the application of thermal support. Depending on the type of injury, the individual may require thermal support to prevent, e.g., swelling of the area. Thus, in one embodiment, a cervical collar is provided that comprises pockets or sleeves around the neck area wherein PCM enclosures are inserted to provide thermal support. In preferred embodiments, the PCMs will have melting points in the range from about 6° C. to about 20° C. The PCM enclosures can be easily inserted, removed, or replaced as desired.

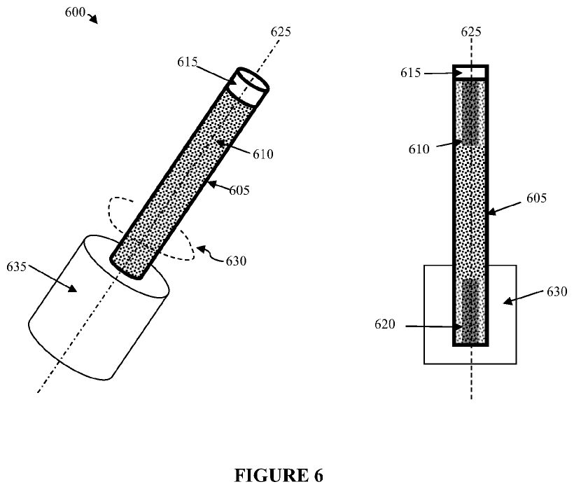

Another aspect of the present invention provides a periodontal cooling device to provide thermal support to gums, teeth, or cheeks following, e.g., dental procedures. An exemplary embodiment of a periodontal chiller 600 is depicted in FIG. 6. An enclosure 605 contains a PCM 610 having a melting temperature ranging from about 0° C. to about 20° C., preferably about 5° C. to about 15° C. In certain embodiments, enclosure 605 is made of a flexible polymer, including polyamide (e.g., nylon), polyethylene (e.g., high density polyethylene), polychlorotrifluoroethene, polystyrene, polyethylene terephthalate, and polypropylene. In a preferred embodiment, enclosure 605 is made of polypropylene. In particular, enclosure 605 may be in the shape of a tube having a longitudinal axis 625, a top end 615, and a bottom end 620. The bottom end 620 of enclosure 605 is shown surrounded by a thermal applicator 635. The thermal applicator 635 may be disposed around the entire outer circumference 630 of the enclosure 605. In some embodiments, only a portion the bottom end 620 of the enclosure 605 is covered by the thermal applicator 635. In particular embodiments, the thermal applicator 635 is water permeable and comprises an absorbent material, e.g., cellulose, low-density polyether, polyester, polyurethane, or polyvinyl alcohol.

In some embodiments, the periodontal chiller 600 is charged to the appropriate temperature. In a particular embodiment, the periodontal chiller 600 contains a PCM 610 having a melting temperature of about 6° C. or about 15° C. The periodontal chiller 600 is charged by placing the device in a refrigerator set at about 0° C. to about 3° C. for about 24 hours or until the PCM has solidified. The periodontal chiller 600 is then dipped into a thermal convection liquid, e.g., water, such that the absorbent material of the thermal applicator 635 is saturated with the thermal convection liquid. In some embodiments, the thermal convection liquid comprises an additive that impacts the melting and/or freezing temperature of the liquid. For example, a non-limiting exemplary thermal convection liquid comprises water and one or more of a salt (e.g., NaCl, KCl, and CaCl₂), gelatin, and/or sugar (e.g., sucrose, glucose, and sorbitol) whereby the freezing temperature of the water is lowered. The thermal applicator 635 is then placed in substantially direct contact with the gums or teeth of a human or animal whereby thermal support is provided.

Thus, this relatively simple and straightforward system can be used to provide a consistent, continuous, and tightly controlled temperature gradient to provide thermal support for a body part of an animal or human or an organ for transplantation. In addition, the thermal consistency devices and systems disclosed herein will improve therapeutic treatments requiring cold or heat treatment without causing frostbite or burning, and allow the wearer to receive thermal support without sacrificing comfort or mobility.

The following examples are provided to describe the present systems, devices, and methods in greater detail. They are intended to illustrate, not to limit, the invention.

### EXAMPLE 1

As pets age, they may develop orthopedic problems. To provide thermal support and greater relief, a thermal consistency system or device comprising at least one enclosure containing a PCM having a melting temperature of about 37° C. may be used. A prototypical enclosure was constructed, which consisted of multiple layers made from flexible materials available from KNF Corp. (Tamaqua, Pa. 18252). The enclosure consisted of four flexible layers that included a polyethylene layer, a polyethylene terephthalate layer, an aluminum layer, and a nylon layer. In particular, the enclosure was formed into a small pouch having the dimensions of approximately 1 inch by 3 inches and filled with SAVENRG™ PCM-OM37P (Rgees, LLC, Arden, N.C. 28704) or PURETEMP™ 37 PCM (Entropy Solutions, Inc., Plymouth Minn. 55441), each having a melting temperature of about 37° C. The enclosure was heat-sealed using a manual impulse laminator to prevent leaks. The pouch was placed in substantially direct contact with the joints of a dog with orthopedic problems, which provided the animal with relief. The flexible layers of the enclosures enable the thermal consistency device to better conform to the topology of the animal's joints and epidermis.

### EXAMPLE 2

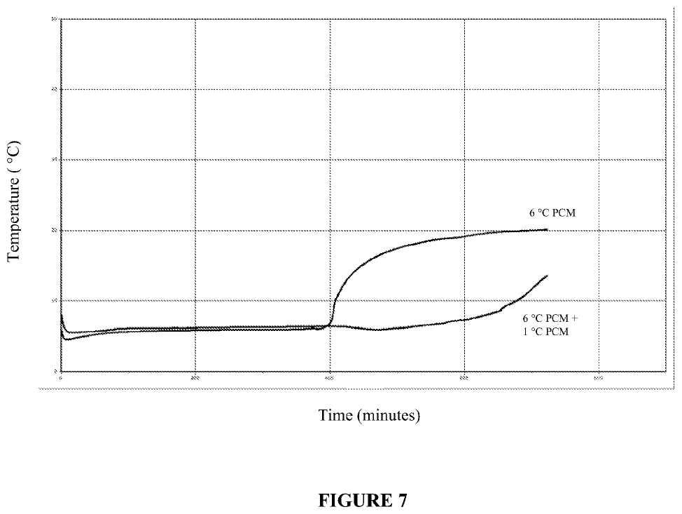

This example describes a thermal consistency system utilizing alternating enclosures containing PCMs with different melting temperatures, such as those depicted in FIGS. 3, 4A, and 4B. Surprisingly, the enclosure containing the PCM with the lower melting temperature (i.e., the cooler enclosure) acts as a “booster” for the enclosure containing the PCM with the higher melting temperature (i.e., the warmer enclosure). As shown in FIG. 7, the warmer enclosure maintains its temperature for approximately 30% longer when compared to the control sample. A thermal consistency device was constructed as described above. One set of enclosures was filled with SAVENRG™ PCM-OM06P (Rgees, LLC, Arden, N.C. 28704) or PURETEMP™ 6 PCM (Entropy Solutions, Inc., Plymouth Minn. 55441), each having a melting temperature of about 6° C. Another set of enclosures was filled with SAVENRG™ PCM-HS01P (Rgees, LLC, Arden, N.C. 28704) or PURETEMP™ 1 PCM (Entropy Solutions, Inc., Plymouth Minn. 55441), each having a melting temperature of about 1° C. The top line shows the temperature of two enclosures, each containing the PCM with a melting temperature of about 6° C. The enclosures maintain a temperature of about 6° C. for approximately 6 hours. However, when one enclosure containing the PCM with a melting temperature of about 6° C. is placed in close proximity to a second enclosure containing the PCM with a melting temperature of about 1° C., the combination maintains a temperature of about 6° C. for over 10 hours. Thus, a thermal consistency system utilizing alternating enclosures having PCMs of different melting temperatures can provide thermal stability for longer periods of time.

### EXAMPLE 3

Professional sports teams benefit both on the field and financially from having highly paid athletes avoid injuries. The thermal consistency systems and devices of the present invention can be used to provide thermal support for these athletes to decrease the number of muscle stiffening injuries. For example, PCMs may be selected that have melting temperatures of about 40° C. or higher and placed in the socks and pants of the athletes during the time that they are not on the field. In addition, the socks and pants of the athletes can be designed to contain pockets or compartments that allow the wearer to readily insert or swap thermal consistency devices based upon need and desired temperature. This application would be especially beneficial for cold weather sports played in open-air stadiums (e.g., football games played at Lambeau Field in Green Bay, Wis., in December and January often see below-freezing temperatures).

### EXAMPLE 4

In addition, it is possible to use a thermal consistency device in combination with thermal transfer fabric to evenly distribute thermal support to an ailing area while avoiding the need to apply wet ice directly to the area. In a non-limiting example, a foot ailment, such as gout, can be treated by providing enclosures filled with a PCM having a melting temperature of about 6° C., or alternatively, at least two alternating enclosures filled with PCMs having melting temperatures of about 1° C. and 6° C. The enclosures may then be placed in substantially direct contact with the calf of the individual and held in place by an elastic bandage. To provide thermal support to the foot ailment, a thin thermal transfer fabric can be placed over the enclosures and then run down the calf and around the foot. Thus, thermal support is applied to the foot without interfering with the wearer's ability to walk.

### EXAMPLE 5

In another non-limiting example, thermal consistency devices consisting of enclosures having the dimensions of about 1 inch by about 3 inches are small enough to be integrated with cervical collars normally used to immobilize patients suspected of having head or neck injuries. Thus, the present systems and methods can provide thermal support to the injured area during transport without interfering with the function of the cervical collar.

### EXAMPLE 6

There is research suggesting that testicular temperature is a factor influencing offspring gender. For example, elevating the testicular temperature may increase the probability of producing female offspring over male offspring. Thus, the thermal consistency devices and systems described herein can be used to apply “warming” temperatures to the scrotum of the male prior to intercourse if a female offspring is desired. In particular, “warming” temperatures approximate to the human body temperature or higher (i.e., 37° C. or higher) are desired. Therefore, under garments can be designed with special pockets or compartments to allow the wearer to insert enclosures containing PCMs with melting temperatures at or above 37° C. Alternatively, if a male offspring is desired, the thermal consistency devices and systems can be used to apply temperatures from about 33° C. to about 36° C. to the scrotum of the male prior to intercourse.

### EXAMPLE 7

This example describes a thermal consistency system utilizing alternating enclosures containing PCMs with different melting temperatures, such as those depicted in FIGS. 3, 4A, and 4B. In this example, two enclosures containing PCMs at warming temperatures were used in combination as described in Example 2, except that the enclosure with the PCM having the higher melting temperature (i.e., the warmer enclosure) acted as a “booster” for the enclosure containing the PCM having the lower melting temperature (i.e., the cooler enclosure). For example, after charging, an enclosure having a PCM with a melting temperature of about 68° C. was placed adjacent to an enclosure having a PCM with a melting temperature of about 80° C. In this case, the PCMs in both enclosures were in the liquid phase (i.e., a liquid-to-solid PCM). As the PCMs freeze, they release energy to their surroundings. As such, the enclosure containing the 80° C. PCM released energy to the enclosure containing the 68° C. PCM and delayed the freezing of the 68° C. PCM thereby maintaining the 68° C. PCM at its transition temperature about 30% longer. If the 68° C. enclosure is placed adjacent to the clothing, or skin underneath the clothing, of an individual, then the 80° C. enclosure can be placed over the 68° C. enclosure, but away from the skin or clothing of the individual, to increase the duration of thermal maintenance to the individual without causing burning. Such applications of prolonged thermal maintenance will be especially useful for preventing frostbite for mountain climbers, scuba divers, navy seals, and others who must endure prolonged exposure to frigid environments.

### EXAMPLE 8

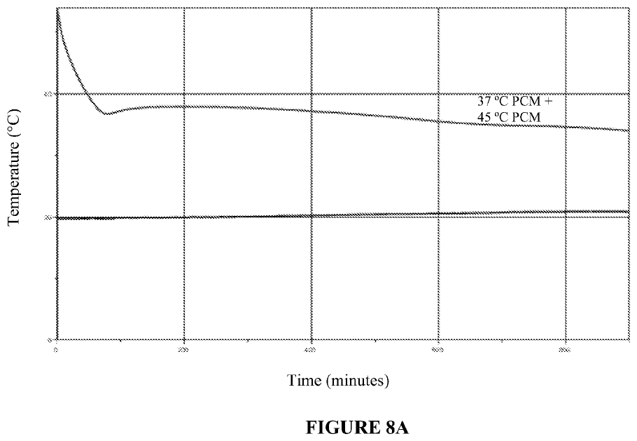

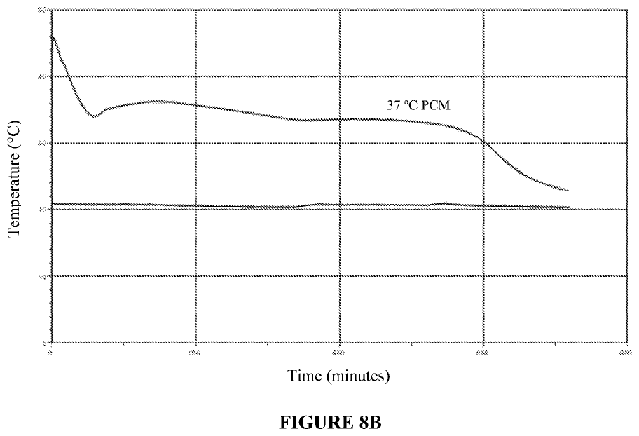

In this example, two enclosures containing PCMs at warming temperatures were used in combination as described in Example 7, except that the enclosure with a PCM having a melting temperature of about 45° C. acted as a “booster” for the enclosure containing a PCM having a melting temperature of about 37° C. The enclosure containing the 45° C. PCM released energy to the enclosure containing the 37° C. PCM and delayed the freezing of the 37° C. PCM thereby maintaining the 37° C. PCM at its transition temperature for a longer period of time as compared to the single 37° C. PCM enclosure. FIG. 8A shows the temperature of the single 37° C. PCM enclosure over a time period of about 720 minutes. FIG. 8B shows the temperature of the 37° C. PCM enclosure and 45° C. PCM enclosure combination over a time period of about 900 minutes. The temperature measurements are summarized in Table 2.

TABLE 2

| Time (minutes) | 37° C. + 45° C. | 37° C. |
|---|---|---|
| 0 | 53.7 | 42.4 |
| 30 | 43.2 | 38.3 |
| 60 | 38.1 | 34 |
| 90 | 36.9 | 35.4 |
| 120 | 37.6 | 36 |
| 150 | 37.8 | 36.2 |
| 180 | 37.9 | 36 |
| 210 | 37.9 | 35.5 |
| 240 | 37.9 | 35.1 |
| 270 | 37.8 | 34.6 |
| 300 | 37.7 | 34.1 |
| 330 | 37.6 | 33.6 |
| 360 | 37.4 | 33.4 |
| 390 | 37.2 | 33.5 |
| 420 | 37 | 33.6 |
| 450 | 36.9 | 33.5 |
| 480 | 36.6 | 33.4 |
| 510 | 36.4 | 33.2 |
| 540 | 36.1 | 32.8 |
| 570 | 35.8 | 32 |
| 600 | 35.5 | 30.3 |
| 630 | 35.2 | 27.4 |
| 660 | 35.1 | 25.1 |
| 690 | 34.9 | 23.7 |
| 720 | 34.8 | 22.7 |

### EXAMPLE 9

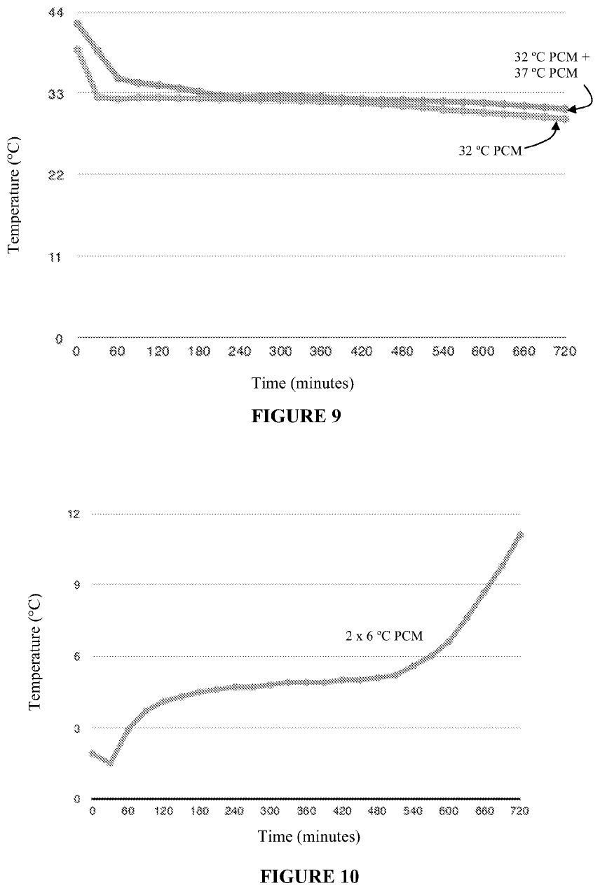

In this example, two enclosures containing PCMs at warming temperatures were used in combination as described in Example 7, except that the enclosure with a PCM having a melting temperature of about 37° C. acted as a “booster” for the enclosure containing a PCM having a melting temperature of about 32° C. The enclosure containing the 37° C. PCM released energy to the enclosure containing the 32° C. PCM and delayed the freezing of the 32° C. PCM thereby maintaining the 32° C. PCM at its transition temperature for a longer period of time as compared to the single 32° C. PCM enclosure. FIG. 9 shows the temperature of the 37° C. PCM enclosure and 32° C. PCM enclosure combination (top line) as compared to the single 37° C. PCM enclosure (bottom line) over a time period of about 720 minutes. The temperature measurements are summarized in Table 3.

TABLE 3

| Time (minutes) | 32° C. + 37° C. | 32° C. |
|---|---|---|
| 0 | 42.4 | 38.9 |
| 30 | 38.7 | 32.5 |
| 60 | 35 | 32.2 |
| 90 | 34.4 | 32.4 |
| 120 | 34.1 | 32.4 |
| 150 | 33.7 | 32.3 |
| 180 | 33.2 | 32.3 |
| 210 | 32.7 | 32.2 |
| 240 | 32.5 | 32.2 |
| 270 | 32.6 | 32.1 |
| 300 | 32.7 | 32.1 |
| 330 | 32.6 | 32 |
| 360 | 32.5 | 31.9 |
| 390 | 32.3 | 31.8 |
| 420 | 32.2 | 31.7 |
| 450 | 32.1 | 31.5 |
| 480 | 32.1 | 31.3 |
| 510 | 32 | 31.1 |
| 540 | 31.9 | 30.8 |
| 570 | 31.8 | 30.6 |
| 600 | 31.7 | 30.4 |
| 630 | 31.5 | 30.2 |
| 660 | 31.3 | 30 |
| 690 | 31.1 | 29.8 |
| 720 | 30.9 | 29.5 |

### EXAMPLE 10

To test the ability of the PCM enclosures to provide thermal support to temperature-sensitive medicinals and other materials during transport, two PCM enclosures containing PCMs having a melting temperature of about 6° C. were placed inside a lockbox, and the temperature of the lockbox interior was measured at various timepoints for 720 minutes. As shown in Table 4 and FIG. 10, the PCM enclosures maintained the internal temperature of the lockbox within about 2° C. of 6° C. for over 630 minutes.

TABLE 4

| Time (minutes) | 6° C. |
|---|---|
| 0 | 1.9 |
| 30 | 1.5 |
| 60 | 2.9 |
| 90 | 3.7 |
| 120 | 4.1 |
| 150 | 4.3 |
| 180 | 4.5 |
| 210 | 4.6 |
| 240 | 4.7 |
| 270 | 4.7 |
| 300 | 4.8 |
| 330 | 4.9 |
| 360 | 4.9 |
| 390 | 4.9 |
| 420 | 5 |
| 450 | 5 |
| 480 | 5.1 |
| 510 | 5.2 |
| 540 | 5.6 |
| 570 | 6 |
| 600 | 6.6 |
| 630 | 7.6 |
| 660 | 8.7 |
| 690 | 9.8 |
| 720 | 11.1 |

### EXAMPLE 11

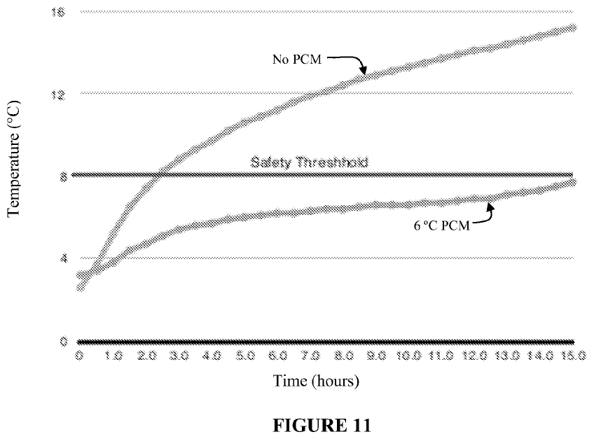

PCM enclosures were tested for their ability to provide consistent thermal support to temperature-sensitive materials (e.g., vaccine vials) exposed to warming temperatures to simulate a refrigeration or freezer failure due to, e.g., a power-outage. Twelve 1.5 ml plastic vials were filled with saline and placed inside a cardboard box with dimensions typical of vaccine storage boxes. PCM enclosures containing PCMs having a melting temperature of about 6° C. were placed in substantially direct contact with the cardboard box. Specifically, two PCM enclosures were placed on the top of the cardboard box with one PCM enclosure placed at the bottom of the cardboard box. The cardboard box and PCM enclosures were placed inside a plastic bin of a size and shape typical of vaccine storage boxes used in hospitals. The bin was insulated with about 0.125 in. (about 0.318 cm) dense foam on three sides. The temperature inside the plastic bin was measured over time to determine how long it took to exceed 8° C., which is the safety threshold for many temperature-sensitive medicinals. The contents of any plastic bin that exceeded 8° C. for 10 over minutes was considered destroyed. As a control, a cardboard box containing twelve 1.5 ml plastic vials filled with saline was placed in a plastic bin. In the control, no PCM enclosures or insulating foam was added to the plastic bin. As shown in Table 5 and FIG. 11, the plastic bin containing the PCM enclosures (bottom line) remained below the 8° C. safety threshold after 15 hours, whereas the control exceeded the safety threshold after about 2.5 hours.

TABLE 5

| Time (hours) | Vials + PCM + Insulation | Vials |
|---|---|---|
| 0 | 3.2 | 2.6 |
| 0.5 | 3.4 | 3.7 |
| 1 | 3.8 | 5.2 |
| 1.5 | 4.4 | 6.5 |
| 2 | 4.7 | 7.4 |
| 2.5 | 5.1 | 8.2 |
| 3 | 5.4 | 8.8 |
| 3.5 | 5.6 | 9.3 |
| 4 | 5.7 | 9.7 |
| 4.5 | 5.9 | 10.2 |
| 5 | 6 | 10.6 |
| 5.5 | 6.1 | 10.9 |
| 6 | 6.2 | 11.2 |
| 6.5 | 6.2 | 11.6 |
| 7 | 6.3 | 11.9 |
| 7.5 | 6.4 | 12.1 |
| 8 | 6.4 | 12.4 |
| 8.5 | 6.5 | 12.7 |
| 9 | 6.6 | 12.9 |
| 9.5 | 6.6 | 13.1 |
| 10 | 6.6 | 13.3 |
| 10.5 | 6.7 | 13.5 |
| 11 | 6.7 | 13.7 |
| 11.5 | 6.8 | 13.9 |
| 12 | 6.9 | 14.1 |
| 12.5 | 6.9 | 14.2 |
| 13 | 7.1 | 14.4 |
| 13.5 | 7.2 | 14.6 |
| 14 | 7.3 | 14.8 |
| 14.5 | 7.5 | 15 |
| 15 | 7.7 | 15.2 |

The present invention is not limited to the embodiments described and exemplified herein, but is capable of variation and modification within the scope of the appended claims.

1. A thermal consistency system comprising:
(a) at least one first enclosure in which is disposed a phase change material, wherein the at least one first enclosure comprises at least one conformable layer, and wherein the phase change material of the at least one first enclosure has a melting temperature range within 2° C. of a predetermined temperature; and
(b) at least one second enclosure in which is disposed a phase change material, wherein the at least one second enclosure comprises at least one conformable layer, wherein the phase change material of the at least one second enclosure has a melting temperature range within 15° C. of the predetermined temperature;
wherein the melting temperature range of the phase change material of the first enclosure is different than the melting temperature range of the phase change material of the second enclosure,
wherein the melting temperature range of the phase change material of the first enclosure is within 10° C. of the melting temperature range of the phase change material of the second enclosure,
wherein each first enclosure is adjacent to at least one second enclosure, wherein each first enclosure is within a proximity to the adjacent second enclosure whereby convective heat transfer occurs between the first enclosure and the adjacent second enclosure,
wherein the predetermined temperature is in a temperature range from about −5° C. to about 85° C., and
wherein the thermal consistency system is enabled to maintain at least the surface of an object, when placed in substantially direct contact with at least one of the first enclosure, within about 2° C. of the predetermined temperature for at least about 1 hour.

2. (canceled)

3. The thermal consistency system of claim 1, wherein:
(a) the melting temperature range of the phase change material of the first enclosure is from about 5° C. to about 10° C., and the melting temperature range of the phase change material of the second enclosure is from about −2° C. to about 4° C.;
(b) the melting temperature range of the phase change material of the first enclosure is from about 30° C. to about 40° C., and the melting temperature range of the phase change material of the second enclosure is from about 37° C. to about 45° C., provided that the melting temperature range of the phase change material of the second enclosure is greater than the melting temperature range of the phase change material of the first enclosure; or
(c) the melting temperature range of the phase change material of the first enclosure is from about 65° C. to about 70° C., and the melting temperature range of the phase change material of the second enclosure is from about 75° C. to about 85° C.

4. The thermal consistency system of claim 1, wherein the phase change material of the first enclosure, the phase change material of the second enclosure, or both, comprises at least one inorganic salt, hydrated inorganic salt, organic molecule, or any combination thereof.

5. The thermal consistency system of claim 4, wherein the at least one inorganic salt is selected from the group consisting of NaCl, KCl, and CaCl₂.

6. (canceled)

7. The thermal consistency system of claim 4, wherein the at least one organic molecule is selected from the group consisting of a long chain fatty acid, polyol, paraffin, and polyacrylamide.

8. The thermal consistency system of claim 1, wherein:
(a) the at least one conformable layer of the first enclosure, the second enclosure, or both, comprises a flexible polymer; or
(b) the at least one conformable layer of the first enclosure, the second enclosure, or both, comprises a flexible, thermally conductive material having a thermal conductivity of at least 30 W/mK; or
(c) both (a) and (b).

9. The thermal consistency system of claim 8, wherein the flexible polymer is selected from the group consisting of polyamide, polyethylene, polychlorotrifluoroethene, polystyrene, polyethylene terephthalate, and polypropylene.

10. (canceled)

11. The thermal consistency system of claim 8, wherein the flexible, thermally conductive material comprises a metal selected from the group consisting of aluminum and copper.

12. The thermal consistency system of claim 1, further comprising a conformable outer encasement in which is disposed the at least one first enclosure and the at least one second enclosure, wherein each first enclosure is adjacent to at least one second enclosure, and wherein each first enclosure is within a proximity to the adjacent second enclosure whereby convective heat transfer occurs between the first enclosure and the adjacent second enclosure.

13-15. (canceled)

16. The thermal consistency system of claim 1, further comprising a separator element between each first enclosure and the adjacent second enclosure, wherein each first enclosure does not contact directly the adjacent second enclosure, wherein each first enclosure is within a proximity to the adjacent second enclosure whereby convective heat transfer occurs between the first enclosure and the adjacent second enclosure, and wherein the thermal consistency system is enabled to maintain at least the surface of an object, when placed in substantially direct contact with at least one of the first enclosure, within about 2° C. of the predetermined temperature for at least 6 hours.

17. The thermal consistency system of claim 1 any one of the preceding claims, wherein the convective heat transfer between the first enclosure and the adjacent second enclosure increases the length of time that the thermal consistency system can maintain the surface of the object within about 2° C. of the predetermined temperature by at least 10%.

18. The thermal consistency system of claim 17, wherein the convective heat transfer between the first enclosure and the adjacent second enclosure increases the length of time that the thermal consistency system can maintain the surface of the object within about 2° C. of the predetermined temperature by at least 20%.

19-25. (canceled)

26. A method of applying consistent thermal support to a human or animal body part or to an organ for transplantation within a predetermined temperature range for up to a predetermined time, the method comprising:
(a) providing a thermal consistency device comprising:
(i) at least one first enclosure in which is disposed a first phase change material, wherein the at least one first enclosure comprises at least one conformable layer, and wherein the first phase change material has a melting temperature range within 2° C. of a predetermined temperature; and
(ii) at least one second enclosure in which is disposed a second phase change material, wherein the at least one second enclosure comprises at least one conformable layer, wherein the second phase change material of the at least one second enclosure has a melting temperature range within 15° C. of the predetermined temperature, wherein each first enclosure is adjacent to at least one second enclosure, wherein each first enclosure is within a proximity to the adjacent second enclosure whereby convective heat transfer occurs between the first enclosure and the adjacent second enclosure;
(b) charging the thermal consistency device;
(c) placing the charged thermal consistency device within close proximity to a human or animal body part or an organ for transplantation; and
(d) maintaining the charged thermal consistency device within close proximity to the human or animal body part or organ for transplantation for up to the predetermined time;
whereby the temperature on at least the surface of the human or animal body part or organ for transplantation is maintained within 2° C. of the predetermined temperature for up to the predetermined time, and wherein the predetermined temperature is in a temperature range from about −5° C. to about 85° C.

27. The method of claim 26, wherein the charged thermal consistency device is placed in substantially direct contact with the human or animal body part or organ for transplantation.

28. The method of claim 26, wherein the first phase change material, the second phase change material, or both, comprises at least one inorganic salt, hydrated inorganic salt, organic molecule, or any combination thereof.

29. The method of claim 28, wherein the at least one inorganic salt of the first phase change material, the second phase change material, or both, is selected from the group consisting of NaCl, KCl, and CaCl₂.

30. (canceled)

31. The method of claim 28, wherein the at least one organic molecule of the first phase change material, the second phase change material, or both, is selected from the group consisting of a long chain fatty acid, polyol, paraffin, and polyacrylamide.

32-48. (canceled)

49. The method of claim 26, wherein the thermal consistency device further comprises a first side and a second side, wherein the first side is positioned toward the human or animal body part and the second side is opposite the first side, and wherein the method further comprises placing a thermal transfer fabric over the second side of the thermal consistency device whereby heat is transferred over a larger surface area of the human or animal body as compared to the thermal transfer device in the absence of the thermal transfer fabric.

50. The method of claim 26, wherein the predetermined time is at least 1 hour.

51. The method of claim 50, wherein the predetermined time is at least 6 hours.

52-70. (canceled)
